(19) United States
(12) Patent Application Publication
(10) Pub. No.: US 2026/0303163 A1
(43) Pub. Date: Oct. 1, 2026

(54) Approaches for Spatial Beamforming

(71) Applicant: Telefonaktiebolaget LM Ericsson (publ), Stockholm (SE)

(72) Inventors: Torsten Carlsson, Lund (SE); Peter Almers, Limhamm (SE)

(21) Appl. No.: 19/479,626

(22) PCT Filed: May 22, 2023
(86) PCT No.: PCT/EP2023/063662

§ 371 Date: Oct. 28, 2025

(51) Int. Cl. H04B 7/06; H04L 25/02

(52) U.S. Cl. CPC H04B 7/0617; H04L 25/022; H04L 25/0228

(57) ABSTRACT

A method is disclosed for spatial beamforming using a time-domain beamformer. The method comprises determining frequency-domain channel estimates per antenna port of the time-domain beamformer based on received narrowband reference signaling, and determining beamforming weights of the time-domain beamformer based on the frequency-domain channel estimates per antenna port of the time-domain beamformer. The narrowband reference signaling comprises a plurality of reference signaling occasions distributed over a reference signaling time window. Each reference signaling occasion comprises reference signaling with a reference signaling bandwidth and a respective center frequency, and the reference signaling bandwidth is more narrow than a communication bandwidth for the spatial beamforming. In some embodiments, the center frequencies are distributed within the communication bandwidth, and at least some of the center frequencies are different. Corresponding computer program product, apparatus, and communication node are also disclosed.

### TECHNICAL FIELD

The present disclosure relates generally to the field of wireless communication. More particularly, it relates to spatial beamforming for wireless communication.

### BACKGROUND

Spatial beamforming is a well-known technical concept that is commonly used for wireless communication.

A problem in the context of spatial beamforming is the determination of beamforming weights to be applied for reception and/or transmission.

For example, application of beamforming weights that are not properly matched to the communication channel may result in poor communication performance (e.g., relatively low throughput). Therefore, it is desirable to determine the beamforming weights as adequately as possible.

Determination of beamforming weights is commonly based on reference signaling. Particularly, for reciprocity-based beamforming (e.g., in relation to a time-division duplex, TDD, system), a radio access node may receive uplink (UL) reference signaling in the form of sounding reference signaling (SRS) from a UE, perform channel estimation based on the received reference signaling, determine beamforming weights based on the channel estimation, and use the determined weights for UL reception and/or downlink (DL) transmission beamforming.

Generally, reference signaling adds to the signaling overhead for wireless communication, and thereby impairs the communication performance (e.g., reducing throughput). Therefore, it is desirable to determine the beamforming weights as effectively as possible.

Thus, there is a need for alternative approaches to determination of beamforming weights in the context of spatial beamforming. Preferably, such approaches improve the accuracy of the determined beamforming weights and/or reduce the signaling overhead, and thereby provides improved communication performance compared to other approaches.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method for spatial beamforming using a time-domain beamformer. The method comprises determining frequency-domain channel estimates per antenna port of the time-domain beamformer based on received narrowband reference signaling, and determining beamforming weights of the time-domain beamformer based on the frequency-domain channel estimates per antenna port of the time-domain beamformer. The narrowband reference signaling comprises a plurality of reference signaling occasions distributed over a reference signaling time window. Each reference signaling occasion comprises reference signaling with a reference signaling bandwidth and a respective center frequency, and the reference signaling bandwidth is more narrow than a communication bandwidth for the spatial beamforming.

In some embodiments, the center frequencies are distributed within the communication bandwidth, and at least some of the center frequencies are different.

In some embodiments, at least one of the center frequencies is within an upper half of the communication bandwidth and at least one of the center frequencies is within a lower half of the communication bandwidth.

In some embodiments, the center frequencies are equidistantly distributed over the communication bandwidth.

In some embodiments, the plurality of reference signaling occasions covers only a portion of the reference signaling time window.

In some embodiments, a duration of the reference signaling time window is based on channel time-variability.

In some embodiments, the method further comprises requesting the narrowband reference signaling.

In some embodiments, the frequency-domain channel estimates per antenna port of the time-domain beamformer are determined as an expectation based on the plurality of reference signaling occasions.

In some embodiments, determining beamforming weights of the time-domain beamformer based on the frequency-domain channel estimates per antenna port of the time-domain beamformer comprises transforming the frequency-domain channel estimates per antenna port of the time-domain beamformer to time-domain channel estimates per spatial element of the time-domain beamformer, and determining beamforming weights of the time-domain beamformer based on the time-domain channel estimates per spatial element of the time-domain beamformer.

In some embodiments, transforming the frequency-domain channel estimates per antenna port of the time-domain beamformer to time-domain channel estimates per spatial element of the time-domain beamformer comprises transforming the frequency-domain channel estimates per antenna port of the time-domain beamformer to frequency-domain channel estimates per spatial element of the time-domain beamformer, and transforming the frequency-domain channel estimates per spatial element of the time-domain beamformer to time-domain channel estimates per spatial element of the time-domain beamformer.

In some embodiments, determining beamforming weights of the time-domain beamformer based on the time-domain channel estimates per spatial element of the time-domain beamformer comprises discarding at least some time-domain channel estimates to provide a pruned channel estimation of the time-domain beamformer, and determining the beamforming weights of the time-domain beamformer based on the pruned channel estimation of the time-domain beamformer.

In some embodiments, discarding at least some time-domain channel estimates comprises discarding time-domain channel estimates with power below a noise power threshold of the time-domain beamformer.

In some embodiments, the method further comprises determining the noise power threshold of the time-domain beamformer based on one or more of: an estimated noise variance, a presumed noise distribution, and an expected maximum noise power per tap.

In some embodiments, the beamforming is implemented using a cascade of beamformers comprising at least one instantiation of the time-domain beamformer and at least one frequency-domain beamformer, and the method further comprises applying the determined beamforming weights of the time-domain beamformer to received fullband reference signaling to produce beamformed fullband reference signaling, wherein the fullband reference signaling comprises reference signaling with the communication bandwidth, and providing the beamformed fullband reference signaling at antenna ports of the frequency-domain beamformer.

In some embodiments, a number of antenna ports of the frequency-domain beamformer is lower than a number of antenna ports of the time-domain beamformer.

In some embodiments, the method further comprises determining a fallback beam for the frequency-domain beamformer, wherein the fallback beam comprises a spatial element with a strongest time-domain channel estimate among spatial elements of the time-domain beamformer, and providing an indication of the fallback beam to the frequency-domain beamformer.

In some embodiments, the method further comprises providing an indication of discarded time-domain channel estimates to the frequency-domain beamformer.

In some embodiments, the method further comprises determining the noise power threshold of the time-domain beamformer based on a channel estimation quality difference between the time-domain beamformer and the frequency-domain beamformer.

A second aspect is a computer program product comprising a non-transitory computer readable medium, having thereon a computer program comprising program instructions. The computer program is loadable into a data processing unit and configured to cause execution of the method according to the first aspect.

A third aspect is an apparatus for spatial beamforming using a time-domain beamformer. The apparatus comprises controlling circuitry configured to cause determination of frequency-domain channel estimates per antenna port of the time-domain beamformer based on received narrowband reference signaling, and determination of beamforming weights of the time-domain beamformer based on the frequency-domain channel estimates per antenna port of the time-domain beamformer. The narrowband reference signaling comprises a plurality of reference signaling occasions distributed over a reference signaling time window. Each reference signaling occasion comprises reference signaling with a reference signaling bandwidth and a respective center frequency, and the reference signaling bandwidth is more narrow than a communication bandwidth for the spatial beamforming.

A fourth aspect is a communication node comprising the apparatus of the third aspect.

In some embodiments, the communication node is a network node, a user device, or a server node.

In some embodiments, any of the above aspects may additionally have features identical with or corresponding to any of the various features as explained above for any of the other aspects.

An advantage of some embodiments is that alternative approaches are provided for determination of beamforming weights in the context of spatial beamforming.

An advantage of some embodiments is that the accuracy of the determined beamforming weights is improved compared to other approaches.

An advantage of some embodiments is that the signaling overhead of the determined beamforming weights is decreased compared to other approaches.

An advantage of some embodiments is that communication performance is improved (e.g., throughput is increased) compared to other approaches.

An advantage of some embodiments is that the signal processing complexity is reduced compared to other approaches (e.g., by enabling channel estimation which is more adequate and/or more efficient). For example, reduced signal processing complexity may be associated with one or more of: reduced power consumption, reduced amount of information to be transferred between processing blocks, reduced processing time, and reduced hardware requirements (e.g., clocking speed, physical area, etc.).

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1A is a schematic block diagram illustrating example weight application for beamformed reception;

FIG. 1B is a schematic block diagram illustrating example weight application for beamformed transmission;

FIG. 2 is a schematic block diagram illustrating an example cascade of beamformers according to some embodiments;

FIG. 3A is a flowchart illustrating example method steps according to some embodiments;

FIG. 3B is a flowchart illustrating example method steps according to some embodiments;

FIG. 3C is a flowchart illustrating example method steps according to some embodiments;

FIG. 4A is a flowchart illustrating example method steps according to some embodiments;

FIG. 4B is a flowchart illustrating example method steps according to some embodiments;

FIG. 4C is a flowchart illustrating example method steps according to some embodiments;

FIG. 5A is a pair of plots illustrating an example reference beam set and an example alternative beam set according to some embodiments;

FIG. 5B is a plot illustrating example sum of powers over beams according to some embodiments;

FIG. 6A is a histogram illustrating example channel estimation pruning according to some embodiments;

FIG. 6B is a plot illustrating example probabilities of adequate beam determination;

FIG. 7 is a schematic block diagram illustrating an example beamforming weight calculator according to some embodiments;

FIG. 8 is a schematic block diagram illustrating an example beamforming architecture according to some embodiments;

FIG. 9 is a schematic block diagram illustrating an example apparatus according to some embodiments; and

FIG. 10 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, approaches will be presented for determination of beamforming weights in the context of spatial beamforming. According to some embodiments, the approaches have one or more of the following benefits: accurate determination of beamforming weights, relatively low signaling overhead, relatively high communication performance, and relatively low signal processing complexity (e.g., power consumption, processing time, amount of information to be transferred between processing blocks, hardware requirements, etc.).

As is well known, beamforming archives efficient communication by controlling the alignment of signals to/from different antenna elements, thereby creating an efficient information channel between information layers of a transmitting device/node and a receiving device/node. The alignment may be controlled via beamforming weights. Each beamforming weight typically comprises a complex number (e.g., representing a phase shift or a time delay).

It should be noted that the terms “beamforming” and “precoding”—as used interchangeably herein—are meant to include all suitable alignment of signals for different antenna elements (e.g., beamforming, antenna precoding, spatial filtering, etc.).

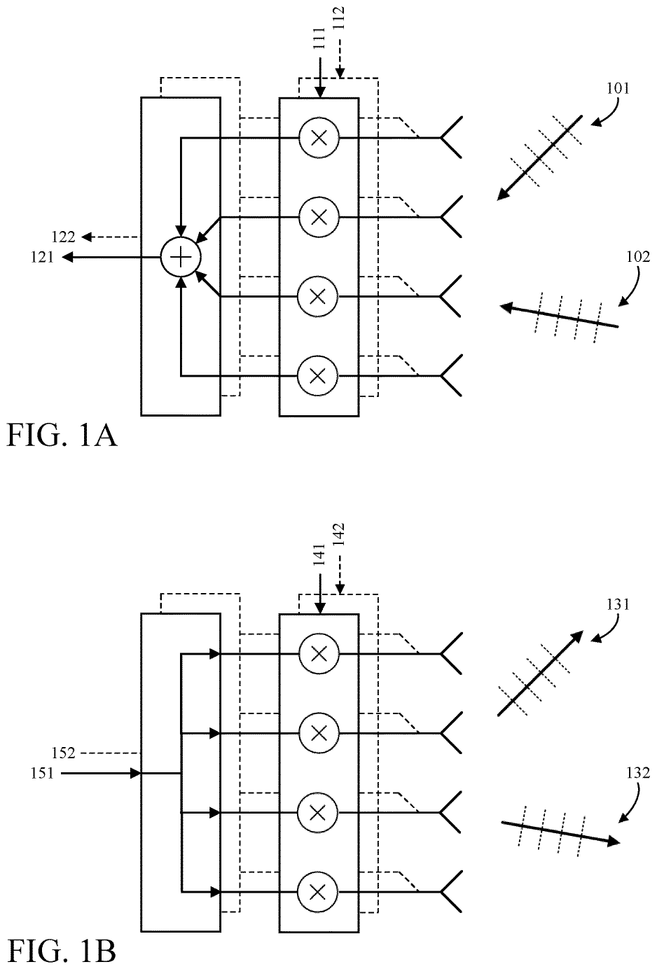

FIG. 1A schematically illustrates an example application of weights for beamformed reception. A signal received via a plurality of antenna elements (illustrated by four antenna elements in FIG. 1A) is processed to provide a first received signal estimate 121 corresponding to a first direction 101 for the received signal, and a second received signal estimate 122 corresponding to a second direction 102 for the received signal.

The signal as received by an antenna element is multiplied by a corresponding weight value, wherein the weight values 111 for the antenna elements collectively correspond to the first direction 101, and the weighted signals from the antenna elements are combined (e.g., summed) to provide the first received signal estimate 121. Similarly, weight values 112 that collectively corresponds to the second direction 102 are applied to provide the second received signal estimate 122 (typically in parallel to providing the first received signal estimate 121).

FIG. 1B schematically illustrates an example application of weights for beamformed transmission.

A signal 151 to be transmitted in a first direction 131 via a plurality of antenna elements (illustrated by four antenna elements in FIG. 1B) is split to provide one signal component for each of the antenna elements. Each of the signal components is multiplied by a corresponding weight value, wherein the weight values 141 collectively correspond to transmission in the first direction 131. Similarly, a signal 152 to be transmitted in a second direction 132 via the plurality of antenna elements is split to provide one signal component for each of the antenna elements, and each of the signal components is multiplied by a corresponding weight value, wherein the weight values 142 collectively correspond to transmission in the second direction 132.

The same signal may be transmitted in several different directions (i.e., 151 and 152 may be identical) and/or different signals may be transmitted in different directions (i.e., 151 and 152 may be different signals).

It should be noted that the principles of FIGS. 1A and 1B are equally applicable for situations with more than two directions for the received signal, as well as for situations with a single direction for the received signal.

Wireless communication system demands continues to increase (e.g., in terms of throughput, bitrate, etc.). To this end, relatively high frequency spectra is becoming utilized (e.g., in fifth generation—5G—mmWave systems). For relatively high frequencies, a relatively large number of antenna elements are typically needed to fulfill link budget requirements. Furthermore, relatively large communication bandwidths are envisioned. A problem in this context is that increasing the number of antenna elements and/or the communication bandwidth typically leads to increased signal processing complexity. As the number of antenna elements and/or the communication bandwidth grows substantially, the signal processing complexity may become cumbersome. This is one issue that may be addressed by application of some embodiments presented herein.

Beamforming (compare with FIGS. 1A and 1B) may be used to reduce signal processing complexity, since the signal energy is concentrated to one signal path per beam (to be handled by the rest of the signal processing system) instead of one signal path per antenna element. For example, for 5G mmWave systems, more than a thousand physical antenna elements are envisioned and simulations show that less than twenty beams is typically enough to capture a significant portion of the power conveyed by a physical radio channel, so that application of time-domain beamforming can achieve an approximately fifty-fold complexity reduction.

If the beamforming weights are constant over the communication bandwidth, the beamforming may be applied to time-domain signals (termed herein as time-domain beamforming). If the beamforming weights are frequency-dependent, the beamforming should be applied to frequency-domain signals (termed herein as frequency-domain beamforming). For example, time-domain beamforming for an orthogonal frequency division multiplex (OFDM) signal may be applied close to the antenna (before OFDM demodulation/after OFDM modulation) where the OFDM data is represented in the time domain, and frequency-domain beamforming for an OFDM signal may be applied further away from the antenna (after OFDM demodulation/before OFDM modulation) where the OFDM data is represented in the frequency domain and beamforming per sub-carrier (or per sub-carrier group) is possible.

In a radio environment (a.k.a., physical channel, radio channel, radio propagation channel, physical radio propagation channel, etc.) with only one strong component (e.g., a line-of-sight component), one beam is typically enough to capture the received signal waves, and selecting the beam with highest detected power is suitable for determination of the beamforming weights.

However, in a radio environment with more than one strong component (e.g., a line-of-sight component and one or more reflection component(s)), it could lead to inferior performance if only one beam is used for determination of the beamforming weights. Therefore, two or more beams may be selected for determination of the beamforming weights in some situations. For example, for a radio environment with two strong components, it may be beneficial to select the beam with highest detected power together with the beam with second highest detected power.

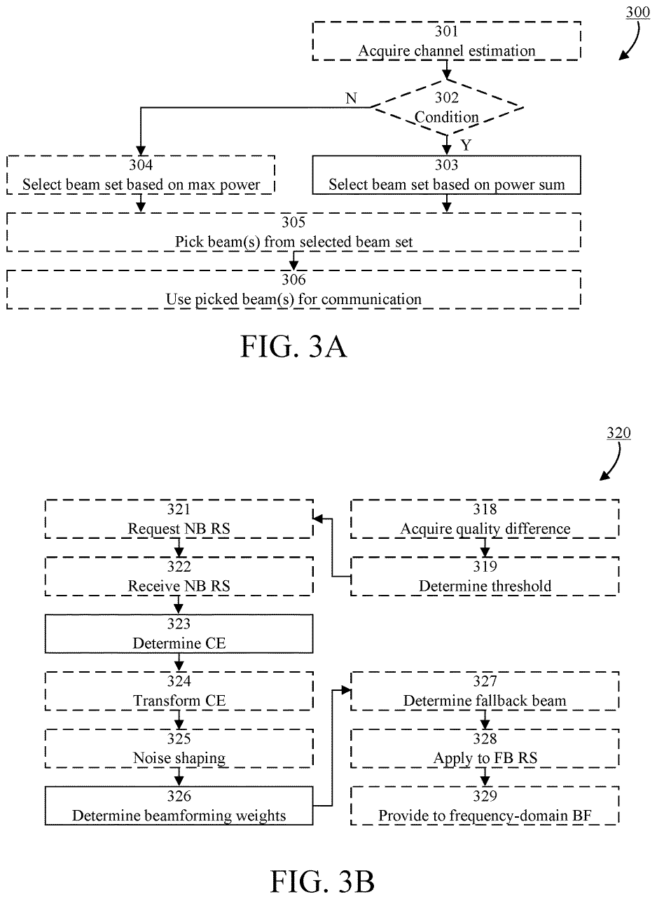

The approach of selecting all the beams with highest detected power is not always possible. For example, when the available beams are subdivided into beam sets and the selection needs to be done from a single one of the beam sets, it may not be possible to select the beam with highest detected power together with the beam with second highest detected power if those two beams belong to different sets. For example, the available beams may be subdivided into beam sets where all beams within a set are orthogonal to each other, while beams in different sets are not (necessarily) orthogonal to each other. Put differently, a beam set may constitute an orthogonal representation of antenna information. Such a subdivision into beam sets may be accomplished by so called “oversampling” of a reference beam set. This problem is addressed by some embodiments (e.g., as exemplified by FIG. 3A), by providing approaches for selecting which beam set to use.

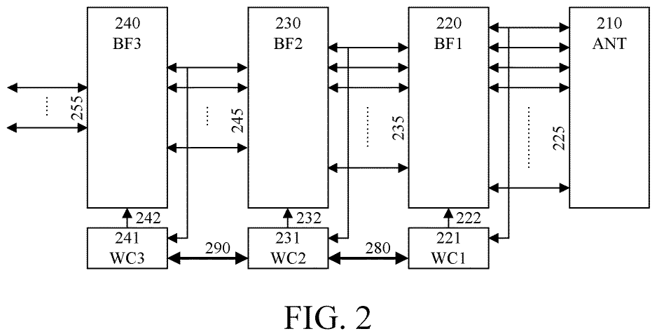

FIG. 2 is a schematic block diagram illustrating an example beamforming architecture with a cascade of beamformers, which may be applied for transmission beamforming and/or for reception beamforming in relation to a collection of physical antenna elements (ANT) 210. The collection of physical antenna elements may comprise any suitable collection of physical antenna elements (e.g., antenna elements of a single antenna panel, or antenna elements of two or more cooperating antenna panels). Furthermore, each antenna element may comprise any suitable antenna element (e.g., a single antenna component, or two or more antenna components that collectively make up an antenna sub-array).

The collection of physical antenna elements 210 is connected to a first beamformer (BF1) 220 via a number Nₚₐ of (physical) antenna ports 225 connecting the first beamformer 220 to the antenna elements 210, the first beamformer 220 is connected to a second beamformer (BF2) 230 via a number N_{bf1_va} of (virtual) antenna ports 235 connecting the second beamformer 230 to the first beamformer 220, and the second beamformer 230 is connected to a third beamformer (BF3) 240 via a number N_{bf2_va} of (virtual) antenna ports 245 connecting the third beamformer 240 to the second beamformer 230. The third beamformer 240 is configured to provide information (data) corresponding to a signal received by the antenna elements 210 and/or accept information (data) to be transmitted by the antenna elements 210, as illustrated by 255.

Each of the beamformers 220, 230, 240 has an associated beamforming weight calculator (WC1, WC2, WC3) 221, 231, 241, which is configured to provide beamforming weight values 222, 232, 242 to the corresponding beamformer 220, 230, 240. In some embodiments, the beamforming weight values 222, 232, 242 is based on received reference signals as manifested at the corresponding antenna ports 225, 235, 245.

Alternatively or additionally, the beamforming weight values 222, 232, 242 may be based on other information than received reference signals as manifested at the corresponding antenna ports 225, 235, 245. For example, when the first beamformer 220 is an analog beamformer, the received reference signals as manifested at the antenna ports 225 might not be used by the weight calculator 221. Instead, the weight calculator 221 might use a priori information regarding location of UE(s) to select a suitable subspace for beamforming by 220. Such a priori information may, for example, be available via signaling from UE(s) indicating which beam(s) the UE(s) received with highest power during downlink beam sweeping.

According to some embodiments, the beamformers 220, 230, 240 may exchange information other than the signal information (data) transferred via the antenna ports 225, 235, 245. This is exemplified in FIG. 2 by connections 280, 290 between subsequent pairs of the beamforming weight calculators 221, 231, 241.

Together, the cascaded beamformers 220, 230, 240 implement the weighting and summation/split exemplified in FIGS. 1A and 1B.

By splitting the beamforming functionality into two or more steps, the signal processing complexity can be reduced. By successively concentrating signal energy, the signal processing complexity required by each of the cascaded beamformers 220, 230, 240 is controlled and the total signal processing complexity may be reduced compared to using a single beamformer.

By successively concentrating signal energy, the number of antenna ports 225, 235, 245 can be reduced as a function of processing distance from the physical antenna elements 210. Thus, the number of antenna ports 235 of the second beamformer 230 may be fewer than the number of antenna ports 225 of the first beamformer 220, and/or the number of antenna ports 245 of the third beamformer 240 may be fewer than the number of antenna ports 235 of the second beamformer 230; e.g., Nₚₐ<N_{bf1_va}<N_{bf2_va}. Thereby, the signal processing complexity is reduced by reducing the amount of information to be transferred between the beamformers 220, 230, 240.

It should be noted that other cascades of beamformers are possible. For example, the cascade may comprise more (or less) than three beamformers (e.g., a beamforming architecture with only two cascaded beamformers). Alternatively or additionally, any of the beamformers of the cascade may be a time-domain beamformer or a frequency-domain beamformer. Yet alternatively or additionally, any of the beamformers of the cascade may be an analog beamformer or a digital beamformer.

The proposed principles for beamforming weight determination are suitable for application in the context of cascades of beamformers (e.g., as exemplified in FIG. 2). However, it should be noted that some embodiments are equally applicable in other contexts, such as a beamforming architecture with a single beamformer.

Generally, beamforming may typically be implemented using several data processing blocks (e.g., several application specific integrated circuits-ASICs), possibly handling a combination of analog and digital signals. As already mentioned, the signal processing complexity related to beamforming may become extremely large; including large information flow through antenna ports, large amounts of data to be stored (e.g., in memory buffers), large amounts of data processing, etc. Thus, it may be preferable to have an architecture (hardware and/or software) that enables reduction of the signal processing complexity. A beamforming architecture with cascaded beamformers (compare with FIG. 2) may be suitable for this purpose.

Thus, FIG. 2 illustrates an architecture for mitigating high signal processing complexity related to beamforming. The signal processing complexity is reduced by splitting the precoder functionality into two or more sequential functionality steps (i.e., beamformers). Moving away from the physical antenna elements 210 along the signal processing path, the number of antenna ports 225, 235, 245 is reduced for each functionality step and the precoding of the following functionality step operates on the—thus reduced—set of antenna port signals. In a typical example, there may be 600 physical antenna elements 225 (i.e., Nₚₐ=600), 150 virtual antenna ports 235 from the first beamformer (i.e., N_{bf1_va}=150), 20 virtual antenna ports 245 from the second beamformer (i.e., N_{bf2_va}=20), and the third beamformer may serve 2 information layers 255.

The first beamformer 220 (generally, a beamformer operating closest to the physical antenna elements) may be a precoder operating in the analog time domain. Each of the virtual antenna ports 235 may, for example, be precoding a distinct subset of the antenna ports 225 (non-overlapping mapping from physical antenna ports 225 to virtual antenna ports 235). Typically, each subset has size Nₚₐ/N_{bf1_va}. Thereby, the information dimension is reduced from Nₚₐ to N_{bf1_va}. When the same set of beamforming weights is applied for all of the subsets, the function of the first beamformer 220 may be seen as a spatial filter (i.e., selecting a portion-a broad beam—of the space spanned by the antenna elements of each subset).

The second beamformer 230 (generally, a beamformer operating closest to the physical antenna elements, or a beamformer separated from the physical antenna elements by one or more precoder(s) operating in the time domain) may be a precoder operating in the digital time domain (i.e., non-frequency-dependent operation over the communication bandwidth).

Operation in the digital domain generally increases flexibility. For example, a precoder operating in the digital domain may apply non-overlapping mapping from virtual antenna ports 235 to virtual antenna ports 245, fully overlapping mapping from virtual antenna ports 235 to virtual antenna ports 245 (each virtual antenna port 245 depending on each of the virtual antenna ports 235), or partially overlapping mapping from virtual antenna ports 235 to virtual antenna ports 245. The same set of beamforming weights may be applied for two or more (e.g., all) of the virtual antenna ports 245, or different sets of beamforming weights may be applied for different ones of the virtual antenna ports 245.

In the following, it will be assumed (for illustrative purposes only) that the second beamformer 230 applies fully overlapping mapping from virtual antenna ports 235 to virtual antenna ports 245. For example, the function of the second beamformer 230 may be seen as concentrating the signal as provided at the virtual antenna ports 235 by the first beamformer 220 for each subset of antenna ports 225, into a specific direction for each of the virtual antenna ports 245 (i.e., selecting a narrow beam for each of the virtual antenna ports 245).

The third beamformer 240 (generally, a beamformer operating closest to the physical antenna elements, or a beamformer separated from the physical antenna elements by one or more precoder(s) operating in the time or frequency domain, e.g., a beamformer operating farthest from the physical antenna elements) may be a precoder operating in the digital frequency domain (i.e., enabling frequency-selective operation over the communication bandwidth). Typically (but not necessarily), the third beamformer 240 applies fully overlapping mapping from virtual antenna ports 245 to information layers 255 (each information layer 255 depending on each of the virtual antenna ports 245).

For example, the function of the third beamformer 240 may be seen as combining the information as provided at the virtual antenna ports 245 by the second beamformer 230 for different directions, into data for the information layers 255, wherein the combination is performed over each frequency interval (e.g., sub-band, sub-carrier group, sub-carrier, etc.) where the radio channel is assumed to be frequent flat.

Generally, the overall beamforming should preferably be controlled to spatially cover most of the radio channel towards other device(s)/node(s) which it is desirable to communicate with (e.g., user equipment(s)—UE(s)—when the beamforming is performed in a radio access node).

Also generally, when a cascaded architecture is applied, the signal processing complexity should preferably be reduced by reducing the number of virtual antenna ports.

Definition of a beamformer (i.e., beamforming weight determination) may, generally, be based on reference signaling. For example, defining a beamformer may comprise receiving reference signaling (e.g., sounding reference signaling, SRS, from a UE), performing channel estimation based on the received reference signaling, determining beamforming weights based on the channel estimation, and using the determined weights for transmission beamforming. This is particularly applicable for reciprocity-based beamforming (e.g., in relation to a time-division duplex, TDD, system).

The weight determination may, for example, be performed by a physical and/or functional beamforming weight calculator (compare with 221, 231, 241 of FIG. 2).

If the first beamformer 220 is an analog beamformer, the beamforming weight calculator 221 may typically use a priori information regarding location of UE(s) to select a suitable subspace for beamforming by 220.

To control the second beamformer 230, reference signaling is transmitted by the UE(s). The channel is estimated based on the reference signaling and the beamforming weight calculator 231 determines suitable beamforming for 230 based on the channel estimates. One issue is that the number of virtual antenna ports 235 needed is typically relatively high. For many architectures, there is not sufficient information bandwidth and/or sufficient calculation power in this regard. This problem may be mitigated or solved by using a narrowband receiver, which enables reception and processing of reference signaling in a sub-band of the full communication bandwidth, while using all antenna resources.

If the third beamformer 240 is a frequency dependent beamformer, reference signaling over the full communication bandwidth is typically needed for the beamforming weight calculator 241 to determine suitable beamforming for 240. The channel estimation for 240 is performed for the virtual antenna ports 245 from the second beamformer 230. Hence, the signal processing cost is significantly reduced compared to other approaches, since the number of antenna ports 245 of the third beamformer 240 is reduced compared to the number of antenna ports 235 of the second beamformer 230 (by means of the beamforming in the second beamformer 230).

According to a particular example, the weight determination for any beamformer (e.g., the second beamformer 230) may comprise performing channel estimation based on received reference signaling, transforming the channel estimates to a different domain (e.g., by applying a discrete Fourier transform—DFT—to the channel estimates), determining a noise shaping filter for the channel estimates in the different domain, applying the noise shaping filter to all of the channel estimates, determining a channel covariance (e.g., in the form of an antenna covariance matrix) based on the filtered channel estimates, selecting one or more beams based on the channel covariance, and calculating the beamforming weights based on the selected beam(s).

The transformation between domains typically aims for improving the channel estimation quality. For example, transformation from antenna port domain to beam domain typically concentrates the received power as manifested at the antenna ports, which renders weight determination more accurate since low-power beams can be discarded. The same applies to transformation from frequency domain to time domain, whereby the received power over frequency is manifested in the form of a delay power profile, which renders weight determination more accurate since low-power delays can be discarded.

Generally, when the power of a beam is referred to herein, it may refer to the power of received reference signaling that is detected for the beam. The power of a beam may, for example, be seen as representing a channel component in the spatial (beam) dimension.

FIG. 3A illustrates an example method 300 for spatial beamforming according to some embodiments. For example, the method 300 may be performed by a beamforming weight calculator (compare with 221, 231, 241 of FIG. 2) for a beamformer of a cascaded architecture, or for a standalone beamformer.

The method 300 is applicable when there is a plurality of sets of available beams (available beam sets) and all selected beams needs to belong to the same set of available beams.

According to some embodiments, each beam set in the plurality of sets of available beams comprises a collection of orthogonal beams (e.g., DFT beams, or beams acquired by any other suitable transform). For example, each set of available beams may comprise beams corresponding to a DFT decomposition of a spatial covariance matrix for the channel.

The plurality of available beam sets may comprise a reference beam set and one or more alternative beam sets with a respective spatial offset relative to the reference beam set. For example, each of the reference beam set and the alternative beam set(s) may be an orthogonal beam set; where all beams in a set are orthogonal to each other.

The alternative beam sets may be derived by so called “oversampling” of the reference beam set (e.g., providing the reference beam set as a set of DFT—or other transform—beams with center beam at a spatial reference angle, and each alternative beam set as a corresponding set of DFT—or other transform—beams with center beam at an alternative angle, wherein the offset is defined by the difference between the alternative angle and the reference angle).

Generally, beam set oversampling may be seen as increasing the number of available beams. When DFT-beams are used, beam set oversampling is typically associated with increased resolution in frequency domain. It should be noted that the overall collection of beams that is achieved by oversampling are generally not orthogonal to each other; even if the reference beam set is a set of orthogonal beams.

Generally, the offset may defined an any suitable way. Typically, the offset is defined in a spatial domain such as a beam domain. For example, the offset may be a one-dimensional spatial offset (e.g., a vertical offset or a horizontal offset), a two-dimensional spatial offset (e.g., an offset with a vertical component and a horizontal component), or a multi-dimensional spatial offset (e.g., an offset with a vertical component, a horizontal component, and a polarization component).

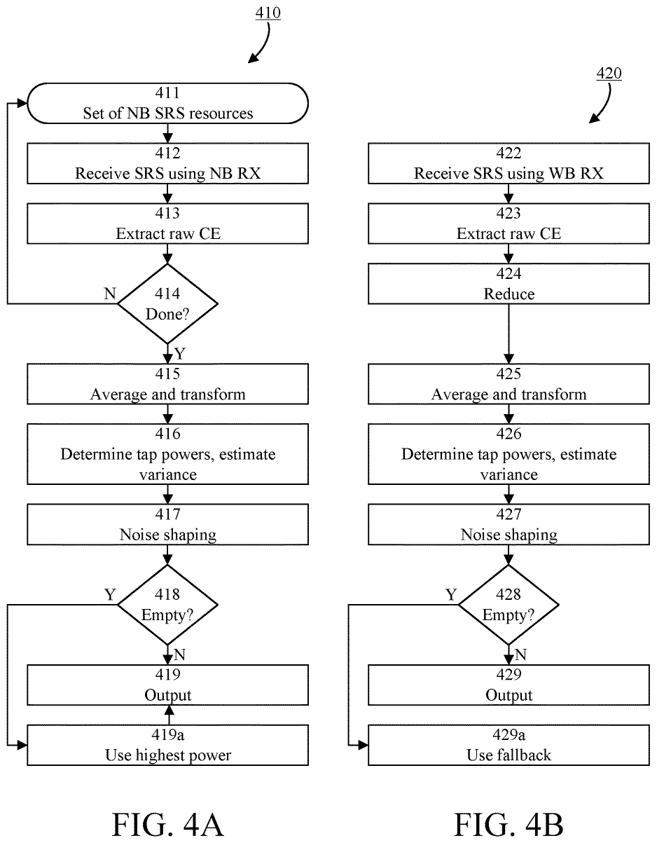

For some types of beam sets (e.g., some sets of orthogonal beams, such as sets of DFT-beams) there is a straddling loss for spatial directions that are not completely aligned with one of the beams. Beam set oversampling is commonly used to reduce the straddling loss. Straddling loss and beam set oversampling is exemplified for DFT-beams in FIG. 5A (to be described later herein).

As illustrated by step 303, a beam set from the plurality of available beam sets is selected for beamformed communication, wherein the selection is based on a respective sum—for at least one of the available beam sets—of powers over at least two beams in the available beam set. Typically, the respective sum of powers is over the strongest beams (i.e., beams with highest power) in the available beam set. Alternatively or additionally, the respective sum of powers may comprise a scaled power for at least one beam in the available beam set. For example, the power scaling may allocate higher influence on the sum by a particular beam (e.g., the strongest beam) of the available beam set. More generally, the power scaling may allocate different levels of influence on the sum to different beams (e.g., depending on relations between beam powers, and/or depending on beam direction).

In some embodiments, the selection comprises determining the respective sums for two or more (e.g., all) of the available beam sets and selecting the available beam set based thereon. In some embodiments, the selection comprises determining the respective sum for one of the available beam sets, selecting that available beam set if the sum determination fulfills some criterion (e.g., relating to a threshold value), and determining the respective sum for another one of the available beam sets if the criterion is not fulfilled, and so on until the criterion is fulfilled or all available beam sets have been examined.

For example, the respective sums for different available beam sets may be determined using the same amount of beams (i.e., the respective sums for different available beam sets may have the same number of terms). The number of beams used for the determination of the respective sum may, for example, be a predetermined number (e.g., depending on hardware constraints of the beamformer and/or channel estimation quality of a subsequent beamformer in a cascaded architecture).

Then, the selection may comprise determining the respective sums for each of two or more (e.g., all) of the available beam sets and selecting the available beam set with the highest sum of powers. Alternatively, the selection may comprise determining the respective sum for one of the available beam sets, selecting that available beam set if the sum determination fulfills some criterion (e.g., the sum exceeding a first power threshold), and determining the respective sum for another one of the available beam sets if the criterion is not fulfilled, and so on until the criterion is fulfilled or all available beam sets have been examined (in which case the available beam set with the highest sum of powers may be selected).

Alternatively, the respective sums for different available beam sets may be determined using potentially different amounts of beams (i.e., the respective sums for different available beam sets may have different number of terms). Thus, the respective sum of powers is over a variable number of beams in an available beam set. For example, the variable number of beams may correspond to a minimum number of beams for which the respective sum of powers exceeds a second power threshold (which typically has the same value for all available beam sets).

Then, the selection may comprise determining the respective sums for each of two or more (e.g., all) of the available beam sets and selecting the available beam set with the lowest number of beams. Alternatively, the selection may comprise determining the respective sum for one of the available beam sets, selecting that available beam set if the sum determination fulfills some criterion (e.g., the number of terms in the sum being lower than a number of beams threshold), and determining the respective sum for another one of the available beam sets if the criterion is not fulfilled, and so on until the criterion is fulfilled or all available beam sets have been examined (in which case the available beam set with the lowest number of beams may be selected).

The second power threshold may, for example, be specified as a portion of the total power of the available beam set (i.e., a portion of the reference signaling power captured for the available beam set). Alternatively or additionally, the second power threshold may be determined based on signal quality (e.g., as an increasing function of signal quality). The signal quality may, for example, depend on hardware constraints of the beamformer and/or channel estimation quality of a subsequent beamformer in a cascaded architecture.

Generally, the terms “signal quality” and “channel estimation quality” are intended to encompass all suitable metrics for expressing how well a channel estimation can be performed based on received reference signaling. Example metrics for quality include (but are not limited to) signal-to-interference ratio (SIR), signal-to-noise ratio (SNR), signal-to-interference-and-noise ratio (SINR), reference signal received power (RSRP), reference signal received quality (RSRQ), etc. The quality may be determined (e.g., measured) at any suitable point of the signal processing path. For example, the quality may be defined at the physical antenna ports (compare with 225 of FIG. 2), at virtual antenna ports (compare with 235, 245 of FIG. 2), at information layers (compare with 245 of FIG. 2), or may be internal to a beamformer (e.g., at any suitable point in the signal processing path within a beamformer). In some embodiments, the quality may be defined based on a combination of points of the signal processing path (e.g., as a change in quality between two different points of the signal processing path).

As illustrated by optional step 302, the selection according to step 303 may be applied based on whether or not a condition is fulfilled. If the condition is fulfilled (Y-path out of step 302) the beam set is selected in step 303 as explained above. If the condition is not fulfilled (N-path out of step 302) the method 300 proceeds to optional step 304, where a beam set is selected from the plurality of available beam sets based on a maximum beam power among the beams in the available beam set.

For example, step 304 may comprise determining the respective maximum beam power for each of two or more (e.g., all) of the available beam sets and selecting the available beam set with the highest maximum beam power. Alternatively, the selection may comprise determining the respective maximum beam power for one of the available beam sets, selecting that available beam set if the respective maximum beam power fulfills some criterion (e.g., exceeding a threshold value), and determining the respective maximum beam power for another one of the available beam sets if the criterion is not fulfilled, and so on until the criterion is fulfilled or all available beam sets have been examined (in which case the available beam set with the highest maximum beam power may be selected).

The criterion of step 302 may be any suitable criterion. Typically, the criterion may relate to the nature of the estimated channel. To this end, the channel estimation may be acquired before execution of step 302; as illustrated by optional step 301. For example, the criterion of step 302 may stipulate that step 303 is to be executed responsive to channel conditions where a strongest channel path corresponds to less than a threshold portion of the channel capacity (or any other indication of channel conditions with weak, or no, line-of-sight—LoS), and that step 304 is to be executed responsive to channel conditions where the strongest channel path corresponds to more than the threshold portion of the channel capacity (or any other indication of channel conditions with strong LoS).

Generally, the channel capacity may be indicated in any suitable way by the acquired channel estimation. For example, the channel paths may be estimated as corresponding to the available beams of a beam set and the channel capacity may be indicated by the total power of received reference signaling corresponding to all available beams of the beam set.

The selective use of step 303 only when the channel is comparatively rich (e.g., non-LoS) may reduce complexity compared to if step 303 was always used.

Regardless of how the beam set is selected from the plurality of available beam sets (according to step 303 or 304), one or more beams may be picked from the selected beam set, as illustrated by optional step 305. Which beam(s) to pick may be determined according to any suitable approach. Typically, the picked beam(s) correspond to highest power in the selected set.

For example, one single beam may be picked after execution of step 304, while two or more beams may be picked after execution of step 303.

In the latter case, the number of picked beams may be lower than, equal to, or larger than the number beams used for the respective sum of powers of the selected beam set. Alternatively or additionally, the number of picked beams may be a fixed number, or a dynamic number (e.g., corresponding to a minimum number of beams for which a sum of powers exceeds some power threshold; e.g., specified as a portion of the total power of the selected beam set).

The picked beam(s) may be used for beamformed communication, as illustrated by optional step 306. For example, the picked beam(s) may be used for calculating beamforming weights.

Application of the method 300 typically leads to improved beam selection compared to if the beams are always selected from the set of available beams that comprises the beam with highest received reference signal power (since the oversampling beam set with the strongest beam is not always the best oversampling beam set when more than one beam should be used). Thereby, fewer beams may be used for the beamforming weight determination to achieve the same performance (e.g., capture the same power level), or improved performance (e.g., capture more power) may be achieved for the same amount of beams. Thus, beamforming weights may be accurately determined for relatively low signal processing complexity (due to that fewer beams are combined while maintaining communication performance).

An increased number of beams to be used for communication is typically associated with increased signal processing complexity (e.g., ODFM (de-)modulation, channel estimation, data transfer—interface load), storage costs, etc.). Furthermore, a decreased number of beams may increase performance when the signal quality is relatively low. Thus, enabling use of fewer beams without (or comparatively small) reduction of the communication performance is typically desirable.

For example, processing cost may be reduced by use of fewer beams (i.e., when there is less data to process, the processing cost is reduced for various functional blocks). The processing cost is typically growing substantially exponentially with the number of physical and/or virtual antenna ports, which is associated with the number of beams.

Alternatively or additionally, information transfer cost-including costs of buffering/storing—may be reduced by use of fewer beams (i.e., when there is less data to transfer between functional blocks, the transfer cost is reduced). Functional blocks are often spread within and/or between physical units (e.g., ASICs) so that information transfer within and/or between physical units is needed.

Yet alternatively or additionally, power consumption cost may be reduced by use of fewer beams (e.g., since processing and transfer consumes power).

Regarding communication performance, the overall communication performance (e.g., throughput) is related to how well the channel can be estimated based on reference signaling, and how well the beamforming weights can be determined to match the channel. The quality of the reference signal reception depends on the received signal quality (e.g., SNR) at each physical antenna element, which may be variable. Typically, high received signal quality yields accurate channel estimation, while uncertainties limits the channel estimation accuracy at low received signal quality. This type of statistical uncertainty can be controlled by varying the number of beams (e.g., manifested as a variation of a number of virtual antenna ports); using relatively few beams at low received signal quality and relatively many beams at high received signal quality.

Exemplifying some of the principles of the method 300 when performed by a radio access node, a reciprocity-based TDD system is assumed, with an uplink (UL) baseband communication model for sub-carrier k expressed as

$${r}_{k}^{UL} = \sqrt{{γ}_{k}} {H}_{k}^{UL} {t}_{k}^{UL} + {n}_{k} ,$$

where

$${r}_{k}^{UL}$$

represents the received signal,

$${t}_{k}^{UL}$$

represents the transmitted signal,

$${H}_{k}^{UL}$$

represents the effective channel, γₖ represents attenuation, and nₖ represents noise. Then, the covariance matrix \hat{R}^{TD} may be expressed as

$${\hat{R}}^{TD} = {{\sum }_{k = 0}}^{{N}_{nb \_ sc} - 1} {{\hat{H}}_{k}^{UL} ( {\hat{H}}_{k}^{UL} )}^{H} ∈ {ℂ}^{{N}_{ant \_ bs} \times {N}_{ant \_ bs}}$$

where

$${\hat{H}}_{k}^{U L}$$

represents the UL channel estimation based on UL reference signaling (e.g., using sounding reference signal, SRS), N_{nb_sc} represents the number of sub-carriers, and N_{ant_bs} represents the number of physical antenna elements of the radio access node (or the number of virtual antenna ports if the beamformer is not the beamformer closest to the physical antenna elements).

The bold notation is used to indicate vectors and matrices. For example, for a multi-antenna system, the elements of a vector may correspond to the antenna elements.

Assuming that the beamforming weights for a time-domain (TD) beamformer are based on a DFT-decomposition of the covariance matrix, the powers p of the DFT-beams may be expressed as

$$p = diag ( F {\hat{R}}_{pol}^{T D} {F}^{H} ) ,$$

where F∈ [symbol] ^{N}^{_{ant_bs}}^{×N}^{_{ant_bs}} represents the DFT-matrix, and

$${\hat{R}}_{p o l}^{T D}$$

is the covariance matrix for the relevant polarization. In the context of the method 300, the DFT-matrix may be regarded as a reference beam set.

Beamforming weights W^{TD} determined from the reference set may be expressed as W^{TD}=F_{[:,{i}]}∈ [symbol] ^{N}^{_{ant_bs}}^{×N}^{ᵥₐ}, where {i} represents a set of Nᵥₐ selected DFT-beams (e.g., the strongest beam(s) p[i]), and the received signal

$${\tilde{r}}_{k}^{U L}$$

after a TD beamformer using the beamforming weights W^{TD} may be expressed as

$${\tilde{r}}_{k}^{U L} = \sqrt{{γ}_{k}} {\underbrace{{( {W}^{TD} )}^{T} {H}_{k}^{UL}}}_{{UL effective}_{channel}} {t}_{k}^{UL} + {n}_{k} .$$

Using oversampling to create one or more alternative beam sets (e.g., to reduce the straddling loss) may be expressed as adjusting the set of available beams based on the DFT-matrix such that F∈ [symbol] ^{N}^{ₒₛ}^{N}^{_{dft}}^{×N}^{_{ant_bs}} and W^{TD}=F_{[:,{i}]}∈ [symbol] ^{N}^{ₒₛ}^{N}^{_{ant_bs}}^{×N}^{_{beams}}, where Nₒₛ represents an oversampling factor, and N_{ant_bs} is the number of beams in the DFT-matrix.

The beam selection to determine the beamforming weights W^{TD} is typically limited in that all Nᵥₐ selected beams should be picked from the same beam set such that the selected beams are orthogonal. As already mentioned, the beam set to use may be selected based on which beam set has the strongest beam, or the beam set to use may be selected based on a respective sum of beam powers for each beam set (compare with step 303 of FIG. 3A).

The selection of which beam set to use may be seen as a selection of an oversampling offset, nₒₛ∈{0, . . . , Nₒₛ−1}, and the powers p of each available beam set may be sorted in descending order as pₙ_{ₒₛ}=sort(p_{[n}_{ₒₛ}_{:N}_{ₒₛ}_{:(N}_{_{dft}}_{-1)N}_{ₒₛ}₊ₙ_{ₒₛ}_{]})∈ [symbol] ^{N}^{_{dft}}^{×1}.

For the approach where the beam set is selected which has the strongest beam, the beam set selection may be expressed as

$${n}_{o s} = {arg max}_{{n}_{os}} {p}_{{n}_{o s}} [ 0 ] .$$

For the approach where the beam set is selected based on a respective sum of powers over at least two beams in the available beam set (compare with step 303 of FIG. 3A), there are several possibilities; two of which will be presented for exemplification.

According to one example where a fixed number Nᵥₐ of beams are to be picked, the beam set selection may be expressed as

$${n}_{o s} ( {N}_{v a} ) = {arg max}_{{n}_{os}} {\sum }_{p = 0}^{{N}_{v a} - 1} {p}_{{n}_{o s}} [ p ] ,$$

where

$${\sum }_{p = 0}^{{N}_{v a} - 1} {p}_{{n}_{o s}} [ p ]$$

represents the respective sum of powers. Thus, the beam set is selected which has highest cumulative power for Nᵥₐ beams.

According to one example where a variable number Nᵥₐ of beams are to be picked the beam set selection may be expressed as selecting the nₒₛ(Nᵥₐ) that minimizes

$${N}_{v a} = {arg min}_{{{N}_{va}}_{{δ}_{rel \_ pow} ( {N}_{v a} , {n}_{o s} ( {N}_{v a} ) ) \geq {δ}_{t h}}} {δ}_{rel \_ pow} ( {N}_{va} , {n}_{o s} ( {N}_{v a} ) ) ,$$

wherein δₜₕ is a threshold value (compare with the second power threshold described for step 303), and δ_{rel_pow}(Nᵥₐ, nₒₛ(Nᵥₐ)) represents the portion of the total power of the considered beam set nₒₛ that is captured by the Nᵥₐ strongest beams;

$${δ}_{rel \_ pow} ( {N}_{va} , {n}_{o s} ( {N}_{v a} ) ) = {\sum }_{p = 0}^{{N}_{v a} - 1} {p}_{{n}_{o s}} [ p ] / {\sum }_{p = 0}^{{N}_{d f t} - 1} {p}_{{n}_{o s}} [ p ] = {\sum }_{p = 0}^{{N}_{v a} - 1} {p}_{{n}_{o s}} [ p ] / {‖ {\hat{R}}^{T D} ‖}_{F}^{2} ,$$

where

$${\sum }_{p = 0}^{{N}_{v a} - 1} {p}_{{n}_{o s}} [ p ]$$

represents the respective sum of powers. Thus, the beam set is selected which needs the least the number of beams Nᵥₐ to fulfill the constraint δ_{rel_pow}(Nᵥₐ, nₒₛ(Nᵥₐ))≥δₜₕ.

Typically, the threshold value δₜₕ is a number between zero and one. It may be a fixed number, or may be dynamically variable. For example, the threshold value δₜₕ may depend on the received reference signaling quality (e.g., lowering the threshold value as the quality decreases) and/or channel estimation quality—and/or other characteristics—of a subsequent beamformer in a cascaded architecture.

Typically, a relatively low number Nᵥₐ of beams is desirable when the statistical uncertainty of the subsequent beamformer is relatively high, and vice versa. This may be controlled by setting of the number Nᵥₐ of beams to be picked, or by setting the threshold value δₜₕ (where a relatively low threshold value typically corresponds to a relatively low number of beams, and vice versa).

FIG. 3B illustrates an example method 320 for spatial beamforming according to some embodiments. For example, the method 320 may be performed for a digital time-domain beamformer of a cascaded architecture (compare with 230 of FIG. 2), or for a standalone digital time-domain beamformer.

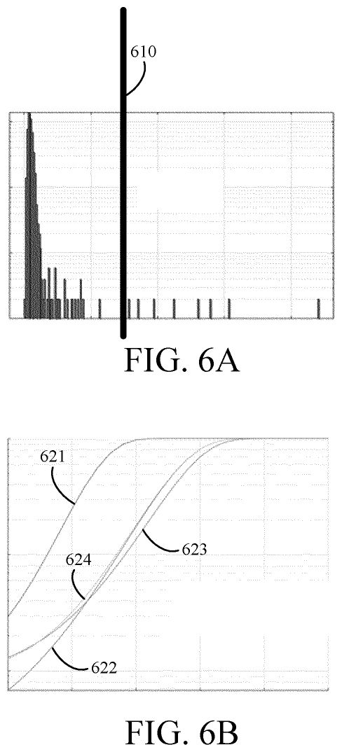

For example, the method 320 may be seen as an example of using several instances of narrowband reference signaling to determine beamforming weights applicable for a communication bandwidth which is larger than the bandwidth of each reference signaling instance. Typically, the bandwidth of each reference signaling instance is substantially smaller than the communication bandwidth. The bandwidth of the narrowband reference signaling may, for example, be configured to be accommodated by a narrowband receiver used for the digital time-domain beamformer (compare with 824 of FIG. 8). An example implementation of a narrowband received is provided by WO 2021/223892 A1.

In step 323, frequency-domain channel estimates are determined per antenna port of the time-domain beamformer (compare with 235 for beamformer 230 of FIG. 2) based on narrowband reference signaling received in optional step 322.

The narrowband reference signaling comprises a plurality of reference signaling occasions distributed over a reference signaling time window (e.g., representing a sounding cycle), and each reference signaling occasion comprises reference signaling with a reference signaling bandwidth and a respective center frequency, wherein the reference signaling bandwidth is more narrow than a communication bandwidth for the spatial beamforming.

The center frequencies preferably fall within the communication bandwidth. In some embodiments, all center frequencies are equal. Alternatively, the center frequencies may be distributed (e.g., equidistantly, or randomly) within the communication bandwidth, and at least some (e.g., all) of the center frequencies may be different. For example, at least one of the center frequencies may be within an upper half of the communication bandwidth and at least one of the center frequencies may be within a lower half of the communication bandwidth. The distribution of center frequencies may, for example, enable the corresponding channel estimates to represent the fullband communication bandwidth.

Typically, the plurality of reference signaling occasions covers only a portion of the reference signaling time window (i.e., there is time gaps between at least some of the reference signaling occasions). For example, the reference signaling occasions may be received within specific reference signaling time slots (e.g., sounding slots), and several reference signaling time slots may be required to accommodate the plurality of reference signaling occasions. Each reference signaling time slot may comprise one or more reference signaling occasion(s), which may occupy the whole reference signaling time slot, or only a portion of it. The reference signaling time window may then refer to a time window extending over all reference signaling time slots required to accommodate the plurality of reference signaling occasions.

The duration of the reference signaling time window may be fixed, or may be dynamically variable. For example, the duration of the reference signaling time window may be based on channel time-variability. Thus, a relatively stable channel may have a longer reference signaling time window duration than a relatively unstable channel, where channel stability refers to spatial stability (i.e., there is no change over time regarding dominating channel direction(s)—corresponding to dominating beam(s)—for a stable channel). It may be preferable to limit the duration of the reference signaling time window such that it is not longer than a time where incident angles of reception can be approximated as constant.

Alternatively or additionally, the frequency-domain channel estimates per antenna port of the time-domain beamformer may be determined as an expectation based on the plurality of reference signaling occasions. For example, step 323 may comprise averaging the channel estimates of two or more reference signaling occasions (e.g., reference signaling occasions with the same center frequency). Typically, averaging the channel estimates in time domain is applicable when the reference signaling occasions are separated by less than the coherence time of the channel.

In step 326, beamforming weights of the time-domain beamformer are determined based on the frequency-domain channel estimates per antenna port of the time-domain beamformer. Optionally, the principles described in connection with FIG. 3A may be applied in connection with the determination of beamforming weights in step 326.

As illustrated by optional step 324, the frequency-domain channel estimates per antenna port may be transformed to time-domain channel estimates per spatial element of the time-domain beamformer before determining the beamforming weights. For example, the transformation may comprise transforming the frequency-domain channel estimates per antenna port to frequency-domain channel estimates per spatial element, and transforming the frequency-domain channel estimates per spatial element to time-domain channel estimates per spatial element. According to some embodiments, the transformation may be implemented by application of a DFT or a discrete cosine transform (DCT). For example, a two-dimensional DFT may be applied for transformation to spatial domain, and a one-dimensional DFT or DCT may be used for transformation to time domain.

As illustrated by optional step 325, at least some time-domain channel estimates may be discarded to provide a pruned (or filtered) channel estimation of the time-domain beamformer, before determining the beamforming weights. This is referred to herein as noise shaping (but may also be called noise reduction, noise suppression, or similar), and has the potential benefit of improving the accuracy of the beamforming weights and/or reducing complexity (e.g., of beamforming weight determination, of information transfer, etc.). Typically (but not necessarily), the noise shaping is identical for all channel estimates (e.g., for channel estimated derived for different reference signaling occasions).

For example, time-domain channel estimates with power below a noise power threshold may be discarded. The time-domain channel estimate power typically relates to a power per delay tap (where each delay tap represents a time-domain sample), averaged over the plurality of reference signaling occasions, and is typically presented per spatial element (e.g., per beam).

The noise power threshold may be fixed or dynamically variable. In some embodiments, the method 320 may comprise determining the noise power threshold, as illustrated by optional step 319.

For example, the noise power threshold may be determined based on one or more of: an estimated noise variance, a presumed noise distribution, and an expected maximum noise power per tap.

Alternatively or additionally, the noise power threshold may be determined based on a channel estimation quality difference between the time-domain beamformer and the frequency-domain beamformer. To this end, the method 320 may comprise receiving a channel estimation quality indication from the frequency-domain beamformer, as illustrated by optional step 318, and use the indication to determine the noise power threshold.

Typically, the frequency-domain beamformer is a frequency selective beamformer (i.e., the beamforming weights may vary over the communication bandwidth) where fullband reference signaling is used to determine the beamforming weights. Due to the bandwidth difference, the number of taps is typically much larger than for the time-domain beamformer. Furthermore, the noise variance is typically higher than for the time-domain beamformer due to lower transmit power per frequency unit (e.g., sub-carrier). The noise variance being higher than for the time-domain beamformer might-additionally or alternatively—be due to the fullband reference signaling using less reference signaling occasions (e.g., one sounding slot) than the narrowband reference signaling.

For example, the channel estimation quality indication from the frequency-domain beamformer may comprise information regarding one or more of: the frequency-domain beamformer bandwidth and/or sub-bands used to implement the frequency selectivity, reference signaling occasions for the frequency-domain beamformer, or a channel estimation quality metric derived therefrom.

Based on channel estimation quality metrics derived for the frequency-domain beamformer and for the time-domain beamformer, a channel estimation quality difference may be determined (e.g., indicating how much higher channel estimation quality is for the time-domain beamformer compared to the frequency-domain beamformer). This difference may be used to offset the noise power threshold, as suitable. For example, the noise power threshold may be increased with increased channel estimation quality difference.

The principles of the noise power threshold may, alternatively or additionally, be applied for the second power threshold of FIG. 3A.

In some embodiments, the method 320 also comprises requesting the narrowband reference signaling as illustrated by optional step 321.

The beamforming weights determined in step 326 may subsequently be applied for signaling over the communication (fullband, FB) bandwidth, as illustrated by optional step 328. The signaling over the communication bandwidth may refer to fullband reference signaling (which may be used for weight determination of a subsequent beamformer of a cascaded architecture) and/or to communication signaling.

As already mentioned, the method 320 may be applied for a standalone beamformer, or for a beamformer of a cascaded architecture (e.g., 230 of FIG. 2). Thus, the beamforming according to the method 320 may be implemented using a cascade of beamformers comprising at least one time-domain beamformer (e.g., 230 of FIG. 2) and at least one frequency-domain beamformer (e.g., 240 of FIG. 2).

For the cascaded case, the beamforming weights determined in step 326 may be applied to received fullband reference signaling in step 328 to produce beamformed fullband reference signaling, and the beamformed fullband reference signaling may be provided at antenna ports (e.g., 245 of FIG. 2) of the frequency-domain beamformer, as illustrated by optional step 329. Other information may also be provided to the frequency-domain beamformer, in step 329.

For example, a fallback beam for the frequency-domain beamformer may be determined in optional step 327 and providing/indicated to the frequency-domain beamformer in step 329. The fallback beam may comprise a spatial element (e.g., a beam) with a strongest time-domain channel estimate among spatial elements of the time-domain beamformer. The fallback beam may be more reliable than a corresponding selection of the strongest beam by the frequency-domain beamformer. This is because the time-domain beamformer uses a smaller reference signaling bandwidth for weight determination than the frequency-domain beamformer, which may result in that the signal quality for weight determination at the frequency-domain beamformer is lower than that of the time-domain beamformer.

Alternatively or additionally, an indication of time-domain channel estimates discarded in step 325 may be provided to the frequency-domain beamformer in step 329.

Application of the method 320 typically leads to relatively low signal processing complexity for determining beamforming weights by enabling channel estimation which is more efficient due to the relatively narrow reference signaling bandwidth. Meanwhile, adequate channel estimation (and, thereby, accurate determination of beamforming weights) for the relatively large communication bandwidth may be achieved by spreading out the reference signaling center frequencies over the communication bandwidth. Furthermore, the reference signaling overhead may be relatively low due to the use of the relatively narrow reference signaling bandwidth.

For example, the method 320 may be particularly useful in the context of an architecture with cascaded beamformers (compare with FIG. 2).

Generally, uplink sounding may be performed based on reference signal transmission from UE(s). Since a typical UE has significantly lower output power than a base station (BS), the received signal quality (e.g., SNR) for the uplink may be significantly lower than the received signal quality for the downlink, which may have a negative effect on channel estimation. This applies generally for any situation with poor signal quality of received reference signaling; not only uplink sounding.

For example, in the context of an architecture with cascaded beamformers, the channel estimation for one or more of the beamformers (e.g., beamformers 230 and 240 of FIG. 2) may be affected by poor signal quality of received reference signaling. Applying the principles of the method 320, the beamformer that uses narrowband reference signaling for weight determination (e.g., beamformer 230 of FIG. 2) may typically experience better signal quality of received reference signaling than if fullband reference signaling was used (e.g., since the UE power can be concentrated within a more narrow bandwidth). Then, applying the beamforming weights (determined based on the narrowband reference signaling) to fullband reference signaling, the signal quality of the fullband reference signaling may be improved before it is provided to the beamformer that uses fullband reference signaling for weight determination (e.g., beamformer 240 of FIG. 2).

Thereby, a possibility is provided to flexibly trade off signal processing complexity (e.g., number of virtual antenna ports) versus performance.

Thus, the principles of the method 320 enables improved channel estimation compared to fullband reference signaling, which can still be valid over the fullband communication bandwidth. Furthermore, improved noise shaping/reduction/suppression is enabled. Based on the (possibly noise shaped) channel estimates, weights of the time-domain beamformer are determined which are configured to capture main channel characteristics while reducing the number of virtual antenna ports for a subsequent beamformer.

Exemplification of some of the principles of the method 320 will be provided in the following. The exemplification is applicable, for example, when the method 320 is performed by a radio access node, and a reciprocity-based TDD system is assumed.

In some examples, the channel estimates determined in step 323 are provided for the beamforming weight determination of step 326 in the form of a covariance matrix. It should be noted that there are suitable alternatives to this form of representation of the channel estimates. For example, covariance may be represented in other forms than a matrix, other correlation formats than covariance may be used, etc.

Thus, a plurality of channel estimates Ĥᵢ, i=1, . . . , Nᵢ, may be determined and a corresponding covariance matrix may be calculated as

$$\hat{R} = \frac{1}{{N}_{i}} {\sum }_{i = 1}^{{N}_{i}} {\hat{H}}_{i} {\hat{H}}_{i}^{H}$$

where Ĥᵢ is a column vector with length corresponding to the number of virtual antenna ports of the time-domain beamformer. The index i spans all resource elements used for reference signaling (e.g., all frequency units—such as sub-carriers—covered by reference signaling, all time units—such as symbols—used for reference signaling, all antenna ports used for receiving reference signaling).

As illustrated by steps 324 and 325, the channel estimates determined in step 323 may be processed before provision for the beamforming weight determination of step 326.

Generally, the covariance matrix depends on channel variations that appear on all antenna ports (e.g., fading variations over time and/or frequency). The time-domain beamformer is typically used over the fullband communication bandwidth (which is typically much larger than the channel coherence bandwidth) and during a time which is much longer than the channel coherence time. Therefore, it is preferable to average out variations as much as possible. For example, it may be desirable to process the channel estimates determined in step 323 to provide a covariance matrix that corresponds to (or approximates) an expectation over time and frequency (i.e., expressing received power per spatial element, while not varying by time and/or frequency).

In step 322, narrowband reference signaling may be received for all reference signaling occasions within a reference signaling time window (e.g., reception from all sounding slots of a full sounding cycle).

For example, the reception in step 322 may be performed by a narrowband receiver 824 (compare with 824 of FIG. 8). A benefit of using a narrowband receiver is that the complexity for receiving full sounding information from all antenna ports (compare with 235 of FIG. 2) becomes lower than for a fullband receiver.

The received information in time domain per virtual antenna port for one reference signaling symbol is a set of samples capturing the narrowband reference signaling. Step 323 may comprise transforming this information to frequency domain and applying a matched filter to provide (for each sounding slot) a set of raw channel samples, where each sample refers to a symbol, an antenna port, and a sub-carrier, for example. If two or more symbols capture the same sub-carrier, an average of the corresponding raw channel samples may be taken over those symbols.

Thereby, step 323 delivers a set of channel samples, where each sample refers to an antenna port and a sub-carrier (referred to herein as frequency-domain channel estimates per antenna port).

To enhance signal quality, the channel samples collected in a reference signaling occasion may be transformed in step 324 to time-domain channel estimates per spatial element (e.g., per beam).

The transforming of step 324 may, for example, comprise applying a two-dimensional DFT per sub-carrier (to provide the channel information as frequency-domain channel estimates per spatial element; instead of per antenna port), and applying a one-dimensional DCT over sub-carriers per beam (to provide the channel information as time-domain channel estimates per spatial element). It should be noted that other transform(s) may be equally suitable for application in step 324.

The resulting time-domain channel estimates per spatial element represent a delay profile for the channel (i.e., time-domain channel samples) for each spatial element (i.e., beam). Each channel sample may be referred to as a delay tap (corresponding to a beam and a delay). Thus, leaving step 324, the raw channel information is in a beam-delay domain rather than an port-subcarrier domain.

Steps 322, 323, 324 are typically performed for all reference signaling occasion in a reference signaling time window, and the beam-delay domain raw channel information is buffered for the subsequent steps.

When channel information for all reference signaling occasion in a reference signaling time window is collected, the power value for each sample is determined, and an average may be taken over the reference signaling occasions per beam and delay tap, to provide a power value per beam and delay tap.

Optionally, the principles described in connection with FIG. 3A may be applied to select one beam set to apply based on the transforming in step 324 (e.g., testing transforms corresponding to two or more beam sets and determining which one to actually apply as explained in connection with FIG. 3A).

Due to the transform(s) applied in step 324, the reference signal information is concentrated and it can be assumed that most of the delay taps contain mostly noise. Thus, all delay taps with relatively low power (e.g., below a noise power threshold) may be discarded in step 325; a process referred to herein as noise shaping, but which may also be called noise reduction, noise suppression, or similar.

Noise shaping is a process of removing taps which can be assumed to contain only noise (e.g., by filtering), which may leave a substantially reduced set of taps which are assumed to carry the channel estimation information, thereby enabling a reduction of the signal processing complexity.

In some embodiments, the noise power threshold is based on an estimated noise variance \hat{σ}² (i.e., a noise power). For example, the noise power threshold may be determined as ρ=K\hat{σ}², where K represents a scaling factor (e.g., determined in step 319).

The noise variance may be estimated in any suitable way. For example, knowledge regarding empty resources may be used to estimate the noise variance. Alternatively or additionally, since the reference signal itself and the resources used for reference signal transmission are known, the reference signal—as presumably received—may be removed from the received signal and the noise variance may be estimated based on the received signal after removal. Yet additionally or alternatively, if it is known (or may be assumed) that the channel corresponds to less than half of the beam taps, the median tap value may be used to estimate the noise variance.

The scaling factor K may be fixed or dynamically variable. For example, the scaling factor may be based on one or more of: a presumed noise distribution, an expected maximum noise power per tap, and a channel estimation quality difference between the time-domain beamformer and the frequency-domain beamformer.

In some embodiments, the scaling factor is based on the expected maximum noise power per tap, which is assumed to be representative of the statistical spread of the noise. The expected value can be calculated based on the number of taps, using an assumption that most taps contain only noise.

When the noise power is assumed to be white and Gaussian, the averaged power can be assumed to follow a Chi-square distribution. The expected power value for the k:th strongest tap, normalized in relation to noise variance, may be expressed as

$$E ( p [ k ] ) = \frac{1}{2 {N}_{m e a s}} {\int }_{0}^{∞} \times \frac{N !}{( N - k ) ! ( k - 1 ) !} * c d {f ( x )}^{N - k} * {( 1 - c d f ( x ) )}^{k - 1} p d f ( x ) d x ,$$

for a Chi-square distribution with 2Nₘₑₐₛ degrees of freedom, where N represents a number of samples, Nₘₑₐₛ represents a total number of reference signaling symbols in a reference signaling time window, and cdf(x) and pdf(x) represent, respectively, the cumulative distribution function and the probability density function of the power.

After noise shaping, the corresponding covariance matrix may be calculated as

$$\hat{R} = \frac{1}{{N}_{i}} {\sum }_{i = 1}^{{N}_{i}} {\hat{H}}_{i} {\hat{H}}_{i}^{H}$$

and provided for the beamforming weight determination of step 326. The index i spans all resource elements used for reference signaling (e.g., all reference signaling occasions within a reference signaling time window, all sub-carriers covered by reference signaling, and all antenna ports).

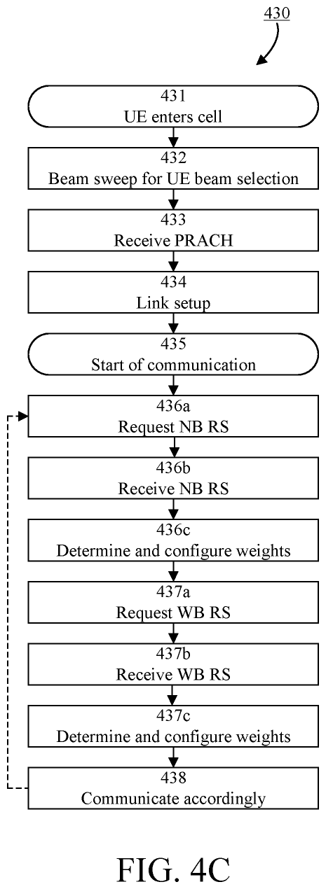

Noise shaping by channel estimation pruning is further exemplified in connection with FIG. 6A, and FIG. 6B exemplifies probabilities of adequate beam determination when the described approach is used.

FIG. 3C illustrates an example method 340 for spatial beamforming according to some embodiments. The method 340 is suitable when the beamforming is implemented using a cascade of beamformers comprising at least one time-domain beamformer (compare with 230 of FIG. 2) and at least one frequency-domain beamformer (compare with 240 of FIG. 2).

Typically, one or more (e.g., all) of steps 342-350 are performed for the time-domain beamformer (e.g., by beamforming weight calculator 231 of FIG. 2) and one or more (e.g., all) of steps 351-359 are performed for the frequency-domain beamformer (e.g., by beamforming weight calculator 231 of FIG. 2).

In some embodiments, some steps of the method 340 (e.g., one or more steps to be performed by the time-domain beamformer) correspond to steps of the method 320 of FIG. 3B as indicated below.

As illustrated by step 341, information is exchanged between the time-domain beamformer and the frequency-domain beamformer (compare with 290 of FIG. 2).

The exchange of information may comprise provision (from the time-domain beamformer to the frequency-domain beamformer) of an indication of a fallback beam for determination of beamforming weights of the frequency-domain beamformer, as illustrated by optional sub-step 350 (compare with step 329 of FIG. 3B). It should be noted that the two or more fallback beams may be provided in some embodiments. For example, different polarizations may relate to different fallback beams. Alternatively or additionally, two or more fallback beams which are suitable for use in combination may be provided.

Alternatively or additionally, the exchange of information may comprise provision (from the time-domain beamformer to the frequency-domain beamformer) of an indication of discarded time-domain channel estimates for determination of beamforming weights of the frequency-domain beamformer, as illustrated by optional sub-step 350 (compare with step 329 of FIG. 3B). It should be noted that an indication of non-discarded time-domain channel estimates is an example of an (implicit) indication of discarded time-domain channel estimates.

Yet alternatively or additionally, the exchange of information may comprise provision (from the frequency-domain beamformer to the time-domain beamformer) of an indication of channel estimation quality of the frequency-domain beamformer for determination of beamforming weights of the time-domain beamformer, as illustrated by optional sub-step 351 (compare with step 318 of FIG. 3B).

It should be noted that the exchange of information may further comprise provision of additional information from the time-domain beamformer to the frequency-domain beamformer and/or from the frequency-domain beamformer to the time-domain beamformer. Such additional information may comprise any information which is determined by one of the beamformers and is suitable for use by the other beamformer (e.g., when determining its beamforming weights). For example, information regarding beams (e.g., directions) selected by the time-domain beamformer and/or information regarding beamforming weights (e.g., amplitudes, phases) determined by the time-domain beamformer may be useful for the frequency-domain beamformer.

Some aspects of the operation of the time-domain beamformer are exemplified by optional steps 342-350.

In step 344, frequency-domain channel estimates are determined per antenna port of the time-domain beamformer (compare with step 323 of FIG. 3B) based on first reference signaling received in step 343 (compare with step 322 of FIG. 3B), and beamforming weights of the time-domain beamformer are determined in step 347 based on the frequency-domain channel estimates per antenna port of the time-domain beamformer (compare with step 326 of FIG. 3B, and with step 303 of FIG. 3A).

In some embodiments, the frequency-domain channel estimates per antenna port of the time-domain beamformer are transformed to time-domain channel estimates per spatial element of the time-domain beamformer before determining the beamforming weights, as illustrated by step 345 (compare with 324 of FIG. 3B). For example, the transformation may comprise transforming the frequency-domain channel estimates per antenna port to frequency-domain channel estimates per spatial element, and transforming the frequency-domain channel estimates per spatial element to time-domain channel estimates per spatial element. Transformation from frequency-domain channel estimates to time-domain channel estimates may, generally, comprise transformation of channel estimates per frequency unit (e.g., sub-carrier or sub-carrier group) to channel estimates per time unit (e.g., time-domain sample). According to some embodiments, the transformation is implemented by application of a DFT or a discrete cosine transform (DCT).

In some embodiments, at least some time-domain channel estimates are discarded to provide a pruned channel estimation, before determining the beamforming weights, as illustrated by step 346 (compare with step 325 of FIG. 3B). For example, time-domain channel estimates with power below a noise power threshold may be discarded. The time-domain channel estimate power typically relates to a power per delay tap (where each delay tap represents a time-domain sample). An indication of time-domain channel estimates discarded in step 346 may be provided to the frequency-domain beamformer in step 350.

The noise power threshold may be fixed or dynamically variable. In some embodiments, the method 340 may comprise determining the noise power threshold, as illustrated by step 342 (compare with step 319 of FIG. 3B). For example, the noise power threshold may be determined based on one or more of: an estimated noise variance, a presumed noise distribution, an expected maximum noise power per tap, and a channel estimation quality difference between the time-domain beamformer and the frequency-domain beamformer, wherein the channel estimation quality difference is based on the indication of channel estimation quality of the frequency-domain beamformer as provided in step 351.

In some embodiments, a fallback beam for the frequency-domain beamformer may be determined, as illustrated by step 348 (compare with step 327 of FIG. 3B). For example, the fallback beam may comprise a spatial element with a strongest time-domain channel estimate among spatial elements of the time-domain beamformer. An indication of the fallback beam determined in step 348 may be provided to the frequency-domain beamformer in step 350.

The beamforming weights determined in step 347 may be applied to received second reference signaling in step 349 (compare with step 328 of FIG. 3B) to produce beamformed second reference signaling, which is provided at antenna ports (e.g., 245 of FIG. 2) of the frequency-domain beamformer, as illustrated by step 350.

In some embodiments, the first reference signaling and the second reference signaling refers to the same reference signaling (i.e., the determination of beamforming weights for the time-domain beamformer in step 347 is based on the same reference signaling as the determination of beamforming weights for the frequency-domain beamformer in step 359).

In some embodiments, the second reference signaling is different from, and subsequent to, the first reference signaling (i.e., the determination of beamforming weights for the frequency-domain beamformer in step 359 is based on different reference signaling than is the determination of beamforming weights for the time-domain beamformer in step 347). For example, the first reference signaling may be narrowband reference signaling and the second reference signaling may be fullband reference signaling, as explained in connection to FIG. 3B.

Some aspects of the operation of the frequency-domain beamformer are exemplified by optional steps 351-359.

In step 354, frequency-domain channel estimates are determined per antenna port of the frequency-domain beamformer (compare with step 344) based on the beamformed second reference signaling provided by the time-domain beamformer in step 350, and beamforming weights of the frequency-domain beamformer are determined in step 359 based on the frequency-domain channel estimates per antenna port of the frequency-domain beamformer (compare with step 347).

For example, when the signal on the virtual antenna ports of the frequency-domain beamformer are time-domain signals (e.g., OFDM signals), step 354 may comprise transforming this information to frequency domain (e.g., by OFDM demodulation) and applying a matched filter to provide a set of raw channel samples, where each sample refers to a symbol, an antenna port, and a sub-carrier, for example. If there are two or more symbols, an average of the corresponding raw channel samples may be taken over those symbols.

Thereby, step 354 delivers a set of channel samples, where each sample refers to an antenna port and a sub-carrier (referred to herein as frequency-domain channel estimates per antenna port).

In some embodiments, the frequency-domain channel estimates per antenna port of the frequency-domain beamformer are transformed to time-domain channel estimates per spatial element of the frequency-domain beamformer before determining the beamforming weights, as illustrated by step 355 (compare with 345). For example, the transformation may comprise expressing the frequency-domain channel estimates per antenna port as frequency-domain channel estimates per spatial element, and transforming the frequency-domain channel estimates per spatial element to time-domain channel estimates per spatial element. Typically, the frequency-domain channel estimates per antenna port of the frequency-domain beamformer corresponds directly to frequency-domain channel estimates per spatial element (e.g., each antenna port of the frequency-domain beamformer corresponds to a spatial element, such as a selected beam, of the time-domain beamformer).

In some embodiments, at least some time-domain channel estimates are discarded to provide a pruned channel estimation, before determining the beamforming weights, as illustrated by step 356 (compare with step 346). For example, time-domain channel estimates with power below a noise power threshold may be discarded. The time-domain channel estimate power typically relates to a power per delay tap (where each delay tap represents a time-domain sample).

The noise power threshold may be fixed or dynamically variable. In some embodiments, the method 340 may comprise determining the noise power threshold, as illustrated by step 352 (compare with step 342). For example, the noise power threshold may be determined based on one or more of: an estimated noise variance, a presumed noise distribution, and an expected maximum noise power per tap.

Alternatively or additionally, the discarding of step 356 may be (at least partially) based on the indication provided in step 350, of time-domain channel estimates discarded for the time-domain beamformer in step 346. For example, step 356 may comprise discarding time-domain channel estimates corresponding to some, or all, of the time-domain channel estimates discarded for the time-domain beamformer.

The fallback beam provided by the time-domain beamformer may be used for determining beamforming weights of the frequency-domain beamformer when the beamformed second reference signaling fails to fulfill a quality condition as illustrated by step 357.

When the quality condition is fulfilled (Y-path out of step 357), the process proceeds to step 359 where the beamforming weights of the frequency-domain beamformer are determined based on the beamformed second reference signaling. For example, the remaining power after noise shaping in step 356 may be used to calculate the corresponding covariance matrix, which may be provided for the beamforming weight determination of step 359.

When the quality condition is not fulfilled (N-path out of step 357), the process proceeds to step 358 where the fallback beam is imposed, and the beamforming weights of the frequency-domain beamformer are determined based on the fallback beam in step 359.

The quality condition may be any suitable condition. For example, the quality condition may comprise that the pruned channel estimation of the frequency-domain beamformer comprises at least one time-domain channel estimate. Alternatively or additionally, the quality condition may comprise that the beamformed second reference signaling exceeds some quality threshold (e.g., a SNR threshold).

Application of the method 340 typically leads to relatively low signal processing complexity for determining beamforming weights by using successive determination as enabled by the cascaded architecture, where each cascade stage aims to eliminate information which is not useful for the subsequent weight determination. When the signal quality at the antenna ports of the frequency-domain beamformer is relatively low, the accuracy of the beamforming weights may be improved by using the fallback beam. Alternatively or additionally, the noise shaping of the time-domain beamformer may be improved by using the indication of channel estimation quality of the frequency-domain beamformer. Yet alternatively or additionally, the noise shaping of the frequency-domain beamformer may be improved by using the indication of discarded time-domain channel estimates of the time-domain beamformer.

For example, application of noise shaping for the time-domain beamformer may entail improved channel estimate quality for the subsequent frequency-domain beamformer, which enables increased communication throughput.

Alternatively or additionally, application of noise shaping for the time-domain beamformer may entail channel estimation with dynamically variable richness (e.g., relating to the number of channel paths). This may be utilized to dynamically vary the amount of channel information transferred from the time-domain beamformer to the subsequent frequency-domain beamformer (e.g., the number of used antenna ports, compare with 245 of FIG. 2). For example, the number of used antenna ports may be selected to fulfill a channel estimate quality condition.

The method 340 may be used to handle noise sensitivity when frequency-dependent beamforming weights are to be determined for the frequency-domain beamformer based on channel estimates, while not un-necessarily increasing signal processing complexity. According to some embodiments, the noise sensitivity is reduced and the beamforming weights for the frequency-domain beamformer are improved (e.g., in terms of accuracy and/or robustness).

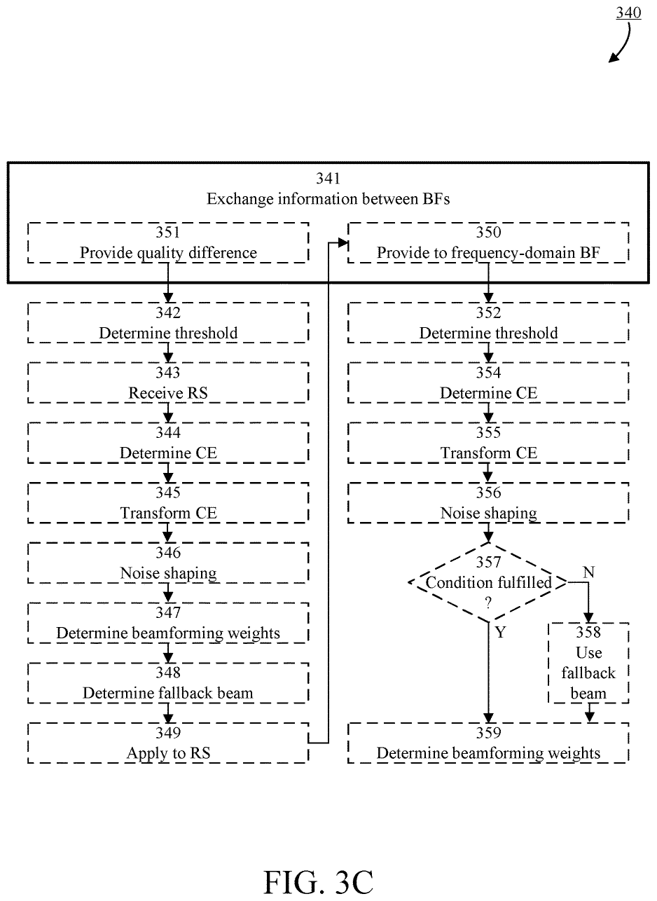

FIG. 4A illustrates an example method 410 according to some embodiments. For example, the method 410 may be seen as a variant of the method 320 of FIG. 3B and/or a variant of a portion of the method 340 of FIG. 3C.

As illustrated by 411 and the N-path out of 414, a set of narrowband (NB) sounding reference signal (SRS) resources (e.g., sounding slots) is processed.

In step 412 (compare with 322 of FIG. 3B and 343 of FIG. 3C), SRS is received over all virtual antenna ports using a NB receiver (RX).

In step 413 (compare with 323 of FIG. 3B and 344 of FIG. 3C), raw channel estimates (CE) are extracted per resource element (e.g., symbols within the sounding slot) of the sounding.

Averaging over symbols may be applied, as suitable.

When all NB SRS resources (e.g., in a reference signaling time window) have been processed (Y-path out of 414), averaging over the set of NB SRS resources is applied and the result is transformed so that the channel estimation is represented as taps per beam, as illustrated by step 415 (compare with 324 of FIG. 3B and 345 of FIG. 3C).

In step 416, tap powers are determined and the noise variance is estimated.

In step 417 (compare with 325 of FIG. 3B and 346 of FIG. 3C), pruning is applied to implement noise shaping (e.g., by removal of all taps with power below a threshold value).

When there is one or more remaining tap(s) after noise shaping (N-path out of 418), the method proceeds to step 419, where an output based on the noise shaped channel estimates is provided for weight determination (e.g., in the form of a covariance matrix).

If no taps remain (Y-path out of 418), the tap with highest power (e.g., per polarization) may be used, as illustrated in step 419a.

FIG. 4B illustrates an example method 420 according to some embodiments. For example, the method 420 may be seen as a variant of a portion of the method 340 of FIG. 3C.

In step 422 (compare with 350 of FIG. 3C), SRS is received for a sounding resource over all virtual antenna ports using a wideband (WB) receiver.

In step 423 (compare with 354 of FIG. 3C), raw channel estimates (CE) are extracted per resource element (e.g., symbols within the sounding slot) of the sounding.

The raw channel estimates (CE) may be reduced based on a priori information (e.g., a filter corresponding to noise shaping of a previous beamformer), as illustrated by step 424.

In step 425, averaging over the resource elements is applied and the result is transformed so that the channel estimation is represented as taps per beam, as illustrated by step 425 (compare with 355 of FIG. 3C).

In step 426, tap powers are determined and the noise variance is estimated.

In step 427 (compare with 356 of FIG. 3C), pruning is applied to implement noise shaping (e.g., by removal of all taps with power below a threshold value).

When there is one or more remaining tap(s) after noise shaping (N-path out of 428), the method proceeds to step 429, where an output based on the noise shaped channel estimates is provided for weight determination.

If no taps remain (Y-path out of 428), a fallback beam may be used, as illustrated in step 429a (compare with step 358 of FIG. 3C).

FIG. 4C illustrates an example method 430 according to some embodiments. For example, the method 430 may be seen as a variant of the method 340 of FIG. 3C.

When a UE enters a cell as illustrated by 431, a beam sweep is performed in step 432 for beam selection by the UE. When a random access request is received over the physical random access channel (PRACH) as illustrated by step 433, a link is set up as illustrated by step 434, and communication is started as illustrated by 435.

The BS requests NB RS in step 436a and receives the NB RS in step 436b (compare with 343 of FIG. 3C). In step 436c, the received NB RS is used to determine beamforming weights for one beamformer (e.g., a time-domain beamformer; compare with 230 of FIG. 2) and configure that beamformer accordingly (compare with 347 of FIG. 3C).

The BS requests WB RS in step 437a and receives the WB RS in step 437b (compare with 343, 349, 350 of FIG. 3C). In step 437c, the received WB RS is used to determine beamforming weights for another, subsequent, beamformer (e.g., a frequency-domain beamformer; compare with 240 of FIG. 2) and configure that beamformer accordingly (compare with 359 of FIG. 3C).

The determined beamforming weights are used for communication as illustrated by 438, while the weight determination based on reference signaling may be repeated (partially—e.g., for some frequencies—or fully) as needed.

FIGS. 5A and 5B provide some further illustration relating to the beam set selection described in connection with FIG. 3A.

FIG. 5A illustrates an example reference beam set and an example alternative beam set according to some embodiments. The horizontal axes represent a spatial dimension (e.g., spatial directions expressed as angles), and the vertical axes represent antenna gain (e.g., in the form of received power).

The left-hand plot shows a reference beam set comprising DFT-beams 501, 502, 503. For a spatial direction 504, the straddling loss 505 is the antenna gain drop from a maximum antenna gain to the highest achievable antenna gain for any of the DFT-beams at the spatial direction 504. The maximum straddling loss is indicated by 506.

The right-hand plot shows the reference beam set 511 of the left-hand plot, as well as an alternative beam set 512, which is based on oversampling of the reference beam set 511. The offset 517 of the alternative beam set 512 in relation to the reference beam set 511 is defined in the spatial dimension. It can be seen that the straddling loss 515 at the spatial direction 504 is substantially reduced by introduction of the alternative beam set 512. The beam selection to determine the beamforming weights is typically limited in that all selected beams should be picked from the same beam set such that the selected beams are orthogonal. That is, in the example of FIG. 5A, all beams should be picked from 511, or all beams should be picked from 512.

FIG. 5B illustrates example sum of powers over beams for different number of beams. The horizontal axis represents the number Nᵥₐ of beams, and the vertical axis represents the sum of powers

$${\sum }_{p = 0}^{{N}_{v a} - 1} {p}_{{n}_{o s}} [ p ] .$$

The sum of powers is shown for four different beam sets resulting from DFT-beam oversampling; a first set 531, a second set 532, a third set 533, and a fourth set 534.

If the beam set is selected which has the strongest beam, the fourth set would always be selected since the selection only considers a single beam (compare with Nᵥₐ=1).

For the example where a fixed number Nᵥₐ of beams are to be picked, and the beam set is selected which has highest cumulative power for Nᵥₐ beams, the fourth set would be selected when Nᵥₐ=1 (534 has highest sum value for Nᵥₐ=1), while the third set would be selected when Nᵥₐ=2 (533 has highest sum value for Nᵥₐ=2).

Thus, it can be seen that selecting the beam set which has the strongest beam is not always the optimal approach.

FIG. 6A illustrates example channel estimation pruning (noise shaping) according to some embodiments (compare with step 325 of FIG. 3B and steps 346 and 356 of FIG. 3C, for example).

The horizontal axis represents tap power, the vertical axis represents number of taps, and the distribution of tap power values is represented in the form of a histogram.

An example noise power threshold 610 is also illustrated. Taps corresponding to power values which exceed the noise power threshold 610 (i.e., tap power values to the right of the threshold in FIG. 6A) are assumed to comprise channel estimation information, while taps corresponding to power values which do not exceed the noise power threshold 610 (i.e., tap power values to the left of the threshold in FIG. 6A) are assumed to contain only noise.

FIG. 6B exemplifies statistically calculated probabilities of adequate beam determination when the approach described in connection with FIG. 3B is used. The horizontal axis represents tap SNR, and the vertical axis represents probability of adequate beam determination.

The probability of adequate beam determination (e.g., for the beamformer 230 of FIG. 2) when narrowband reference signaling with multiple sounding slots is used according to the approach described in connection with FIG. 3B is indicated by 621 (reference signaling bandwidth is 4 resource blocks, and 8 sounding slots are used).

For comparison, probabilities of adequate beam determination when narrowband reference signaling with a single sounding slot is used are exemplified 623 (selecting strongest beam; i.e., highest total beam power) and 624 (selecting beam with strongest tap). The probability of adequate detection of strongest tap is shown by 622.

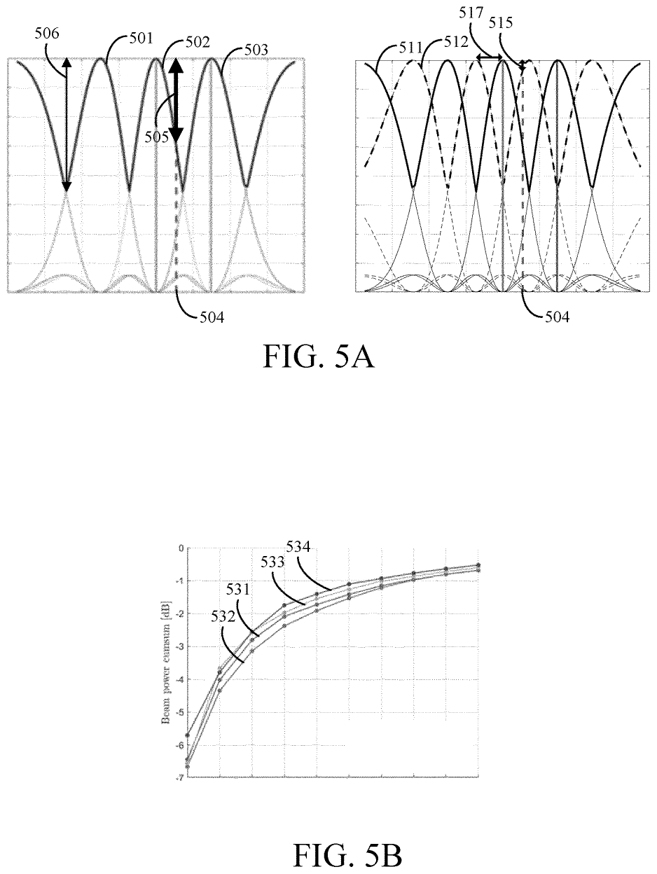

FIG. 7 schematically illustrates an example beamforming weight calculator 700 according to some embodiments. For example, the beamforming weight calculator 700 may be used to implement one or more of the beamforming weight calculators 221, 231, 241 of FIG. 2.

The beamforming weight calculator 700 comprises a channel estimator 710 (CH EST; e.g., channel estimating circuitry or a channel estimation module). The channel estimator 710 is configured to provide raw channel estimates based on reference signaling 702. For example, the channel estimator 710 may implement one or more of steps 301, 323, 344, and 354 of FIGS. 3A-C.

The beamforming weight calculator 700 also comprises a transformer 720 (TRF; e.g., transforming circuitry or a transformation module). The transformer 720 is configured to transform the raw channel estimates (e.g., using DFT). For example, the transformer 720 may implement one or more of steps 324, 345, and 355 of FIGS. 3B-C.

The beamforming weight calculator 700 also comprises a selector 730 (SEL; e.g., selecting circuitry or a selection module). The selector 730 is configured to select one or more beam(s) based on the transformed channel estimates. In some embodiments, the selector 730 first selects an offset indicating a set of beams, and picks the one or more beam(s) from the selected set. To this end, the selector 730 may comprise a offset selector (OS) 735, configured to selects the offset based on a threshold value 704 (e.g., a second power threshold). For example, the selector 730 may implement one or more of steps 302, 303, 305, 326 (partially), 347 (partially), and 359 (partially) of FIGS. 3A-C.

Furthermore, the beamforming weight calculator 700 comprises a beamforming weight determiner 740 (DET; e.g., determining circuitry or a determination module). The beamforming weight determiner 740 is configured to determine the beamforming weights based on the selected beam(s). For example, the beamforming weight determiner 740 may implement one or more of steps 306 (partially), 326, 347, and 359 of FIGS. 3A-C.

FIG. 8 schematically illustrates an example beamforming architecture 800 according to some embodiments. For example, the beamforming architecture 800 may be used in an implementation of the cascaded beamforming architecture of FIG. 2, in which case the first beamformer 220 could be implemented by 830, and/or by 822 and 823. In some embodiments, the beamforming architecture 800 may be used in an implementation of cascaded beamforming using only two beamformers (e.g., corresponding to the second and third beamformers 230, 240 of FIG. 2).

The architecture 800 comprises a plurality of physical antenna elements 830 (compare with 210 of FIG. 2), one or more radio circuitry/ies 820 (e.g., radio ASIC(s)), and beamforming circuitry 810 (e.g., a beamforming ASIC).

Narrowband reference signaling (compare with steps 436a-c of FIG. 4C) received by the physical antenna elements 830 may be provided to the radio circuitry 820 at 881 and processed by uplink (UL) radio front end 823 comprised in the radio circuitry 820. The narrowband reference signaling is then provided at 882 to a narrowband receiver 824 (NB RX) radio circuitry 820, and the output of the NB RX 824 is provided to the beamforming circuitry 810 at 883. The beamforming circuitry 810 comprises narrowband processing circuitry 812 (compare with 231 of FIG. 2) configured to perform narrowband channel estimation (NB CE) and beamforming weight determination for a time-domain beamformer. The weights determined based on the narrowband reference signaling are used to configure a time-domain beamformer (compare with 230 of FIG. 2). For example, the weights determined based on the narrowband reference signaling may be used to configure an uplink time-domain precoder 825 (TD PC UL) at 892 and a downlink time-domain precoder 821 (TD PC DL) at 891; both comprised in the radio circuitry 820.

When the TD PC UL 825 has been configured based on narrowband reference signaling, wideband reference signaling (compare with steps 437a-c of FIG. 4C) received by the physical antenna elements 830 may be provided to the radio circuitry 820 at 881 and processed by the uplink radio front end 823. The wideband reference signaling is then provided to the TD PC UL 825, and the output of the TD PC UL 825 is provided to the beamforming circuitry 810 at 884. The beamforming circuitry 810 comprises wideband processing circuitry 813 (compare with 241 of FIG. 2) configured to perform wideband channel estimation (WB CE) and beamforming weight determination for a frequency-domain beamformer. The weights determined based on the wideband reference signaling as processed by the TD PC UL 825 are used to configure a frequency-domain beamformer (compare with 240 of FIG. 2). For example, the weights determined based on the wideband reference signaling may be used to configure a downlink frequency-domain precoder 811 (FD PC) at 893; comprised in the radio circuitry 820.

When both the FD PC 811 and the TD PC DL 821 have been configured, downlink communication may be performed by letting downlink data 871 be precoded by the FD PC 811, and the result 872 be precoded by the TD PC DL 821. The—thus precoded—downlink data 873 is processed by downlink (DL) radio front end 822 comprised in the radio circuitry 820, and provided to the physical antenna elements 830 at 874.

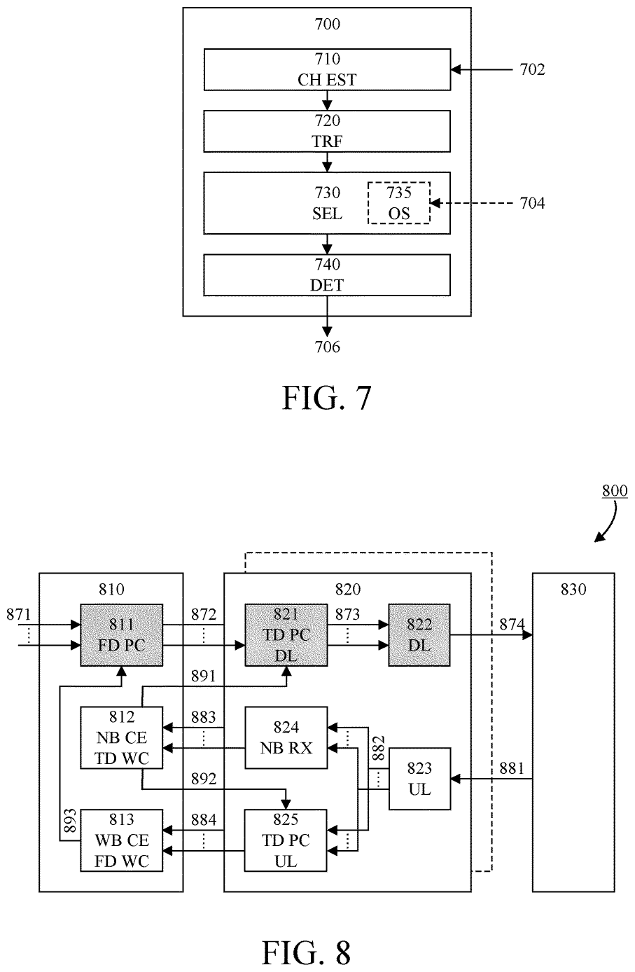

FIG. 9 schematically illustrates an example apparatus 900 according to some embodiments.

For example, the apparatus may be comprised (or comprisable) in a communication node. The communication node is exemplified in FIG. 9 by a network node (NWN) 910; e.g., a base station or a central network node. However, it should be understood that the communication node may be a user device (e.g., a UE) or a server node (e.g., a cloud server) in some embodiments.

Alternatively or additionally, the apparatus 900 may be configured to cause execution of (e.g., execute) one or more method steps as described in any of the FIGS. 3A-C and 4A-C.

Yet alternatively or additionally, the apparatus may be comprised (or comprisable) in an architecture as described in any of the FIGS. 2 and 8; and/or may be configured to control such an architecture.

The apparatus 900 is for spatial beamforming, and comprises a controller 920 (CNTR; e.g., controlling circuitry or a control module). The spatial beamforming is based on reference signaling, which is typically received via a transceiver 930 (TX/RX) of the communication node. A channel estimator 950 (CE) of the communication node—which may, or may not, be comprised in the apparatus 900—is configured to provide raw channel estimates corresponding to the reference signaling appearance at physical/virtual antenna ports. Beamforming weights are determined by the apparatus 900 based on the raw channel estimates. To this end, the controller 920 may comprise, or be otherwise associated with (e.g., connected, or connectable, to), a weight determiner 921 (WD) configured to determine the beamforming weights. The determined beamforming weights are applied by a beamformer 940 (BF)—which may, or may not, be comprised in the apparatus 900—for communication via the transceiver 930.

When each beam set in a plurality of available beam sets comprises a collection of beams, and the plurality of available beam sets comprises a reference beam set and one or more alternative beam sets with a respective spatial offset relative to the reference beam set (compare with FIG. 3A), the controller 920 is configured to cause selection of a beam set from the plurality of available beam sets for beamformed communication, wherein the selection is based on a respective sum—for at least one of the available beam sets—of powers over at least two beams in the available beam set. To this end, the controller 920 may comprise, or be otherwise associated with (e.g., connected, or connectable, to), a selector 922 (SEL) configured to select the beam set. In some embodiments, the controller 920 may be further configured to cause (e.g., by using the selector 922) picking of one or more beams from the selected beam set to be applied for beamformed communication. The controller 920 is configured to cause the selected beam set (and the picked beams) to be used for weight determination.

When the beamforming uses a time-domain beamformer (compare with FIG. 3B), the controller 920 is configured to cause determination of frequency-domain channel estimates per antenna port of the time-domain beamformer based on received narrowband reference signaling, and determination of beamforming weights of the time-domain beamformer based on the frequency-domain channel estimates per antenna port of the time-domain beamformer. The narrowband reference signaling comprises a plurality of reference signaling occasions distributed over a reference signaling time window, wherein each reference signaling occasion comprises reference signaling with a reference signaling bandwidth (which is more narrow than a communication bandwidth for the spatial beamforming) and a respective center frequency. To this end, the transceiver 930 may comprise a narrowband receiver (compare with 824 of FIG. 8) configured to receive the narrowband reference signaling.

When the beamforming is implemented using a cascade of beamformers comprising at least one time-domain beamformer and at least one frequency-domain beamformer (compare with 230 and 240 of FIG. 2, and with FIG. 3C), the controller 920 is configured to cause exchange of information (for weight determination) between the time-domain beamformer and the frequency-domain beamformer, as described earlier herein.

Generally, it should be noted that a feature or advantage described herein in connection with a particular figure or embodiment, is equally applicable—as suitable, and mutatis mutandis—to other figures or embodiments even if not explicitly mentioned in connection thereto.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a communication node.

Embodiments may appear within an electronic apparatus (such as a communication node) comprising arrangements, circuitry, and/or logic according to any of the embodiments described herein. Alternatively or additionally, an electronic apparatus (such as a communication node) may be configured to perform methods according to any of the embodiments described herein.

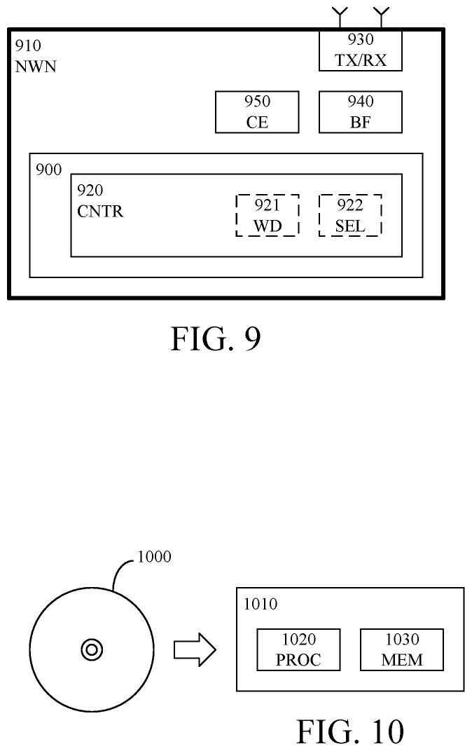

According to some embodiments, a computer program product comprises a non-transitory computer readable medium such as, for example, a universal serial bus (USB) memory, a plug-in card, an embedded drive, or a read only memory (ROM). FIG. 10 illustrates an example computer readable medium in the form of a compact disc (CD) ROM 1000. The computer readable medium has stored thereon a computer program comprising program instructions. The computer program is loadable into a data processor (PROC; e.g., a data processing unit) 1020, which may, for example, be comprised in a communication node 1010. When loaded into the data processor, the computer program may be stored in a memory (MEM) 1030 associated with, or comprised in, the data processor. According to some embodiments, the computer program may, when loaded into, and run by, the data processor, cause execution of method steps according to, for example, any of the methods illustrated in FIGS. 3A-C and 4A-B, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1.-39. (canceled)

40. A method for spatial beamforming using a time-domain beamformer, the method comprising:
sending a request for narrowband reference signaling having a bandwidth suitable for a narrowband receiver used for the time-domain beamformer;
determining frequency-domain channel estimates per antenna port of the time-domain beamformer based on narrowband reference signaling received in accordance with the request, wherein:
the received narrowband reference signaling comprises a plurality of reference signaling occasions distributed over a reference signaling time window,
each reference signaling occasion comprises reference signaling with a reference signaling bandwidth and a respective center frequency, and
the reference signaling bandwidth is more narrow than a communication bandwidth for the spatial beamforming; and
determining beamforming weights of the time-domain beamformer based on the frequency-domain channel estimates per antenna port of the time-domain beamformer.

41. The method of claim 40, wherein the center frequencies are distributed within the communication bandwidth and one or more of the following applies:
at least one of the center frequencies is within an upper half of the communication bandwidth and at least one of the center frequencies is within a lower half of the communication bandwidth; and
the center frequencies are equidistantly distributed over the communication bandwidth.

42. The method of claim 40, wherein one or more of the following applies:
the plurality of reference signaling occasions covers only a portion of the reference signaling time window; and
a duration of the reference signaling time window is based on channel time-variability.

43. The method of claim 40, wherein determining beamforming weights of the time-domain beamformer based on the frequency-domain channel estimates per antenna port of the time-domain beamformer comprises:
transforming the frequency-domain channel estimates per antenna port of the time-domain beamformer to time-domain channel estimates per spatial element of the time-domain beamformer; and
determining beamforming weights of the time-domain beamformer based on the time-domain channel estimates per spatial element of the time-domain beamformer.

44. The method of claim 43, wherein transforming the frequency-domain channel estimates per antenna port of the time-domain beamformer to time-domain channel estimates per spatial element of the time-domain beamformer comprises:
transforming the frequency-domain channel estimates per antenna port of the time-domain beamformer to frequency-domain channel estimates per spatial element of the time-domain beamformer; and
transforming the frequency-domain channel estimates per spatial element of the time-domain beamformer to time-domain channel estimates per spatial element of the time-domain beamformer.

45. The method of claim 43, wherein determining beamforming weights of the time-domain beamformer based on the time-domain channel estimates per spatial element of the time-domain beamformer comprises:
discarding time-domain channel estimates having power below a noise power threshold of the time-domain beamformer, thereby obtaining a pruned channel estimation of the time-domain beamformer; and
determining the beamforming weights of the time-domain beamformer based on the pruned channel estimation of the time-domain beamformer.

46. The method of claim 45, further comprising determining the noise power threshold of the time-domain beamformer based on one or more of the following: an estimated noise variance, a presumed noise distribution, and an expected maximum noise power per tap.

47. The method of claim 40, wherein:
the beamforming is implemented using a cascade of beamformers comprising the following: at least one instantiation of the time-domain beamformer, and at least one frequency-domain beamformer; and
the method further comprises:
applying the determined beamforming weights of the time-domain beamformer to received fullband reference signaling to produce beamformed fullband reference signaling, wherein the fullband reference signaling comprises reference signaling with the communication bandwidth; and
providing the beamformed fullband reference signaling at antenna ports of the frequency-domain beamformer.

48. The method of claim 47, further comprising:
determining a fallback beam for the frequency-domain beamformer, wherein the fallback beam comprises a spatial element with a strongest time-domain channel estimate among spatial elements of the time-domain beamformer; and
providing an indication of the fallback beam to the frequency-domain beamformer.

49. The method of claim 47, further comprising one or more of the following:
providing an indication of discarded time-domain channel estimates to the frequency-domain beamformer; and
determining the noise power threshold of the time-domain beamformer based on a channel estimation quality difference between the time-domain beamformer and the frequency-domain beamformer.

50. An apparatus configured to perform spatial beamforming using a time-domain beamformer, the apparatus comprising controller circuitry configured to cause the apparatus to:
send a request for narrowband reference signaling having a bandwidth suitable for a narrowband receiver used for the time-domain beamformer;
determine frequency-domain channel estimates per antenna port of the time-domain beamformer based on narrowband reference signaling received in accordance with the request, wherein:
the received narrowband reference signaling comprises a plurality of reference signaling occasions distributed over a reference signaling time window,
each reference signaling occasion comprises reference signaling with a reference signaling bandwidth and a respective center frequency, and
the reference signaling bandwidth is more narrow than a communication bandwidth for the spatial beamforming; and
determine beamforming weights of the time-domain beamformer based on the frequency-domain channel estimates per antenna port of the time-domain beamformer.

51. The apparatus of claim 50, wherein the center frequencies are distributed within the communication bandwidth and one or more of the following applies:
at least one of the center frequencies is within an upper half of the communication bandwidth and at least one of the center frequencies is within a lower half of the communication bandwidth; and
the center frequencies are equidistantly distributed over the communication bandwidth.

52. The apparatus of claim 50, wherein one or more of the following applies:
the plurality of reference signaling occasions covers only a portion of the reference signaling time window; and
a duration of the reference signaling time window is based on channel time-variability.

53. The apparatus of claim 50, wherein the controller circuitry is further configured to cause the apparatus to determine the beamforming weights of the time-domain beamformer based on the following operations:
transforming the frequency-domain channel estimates per antenna port of the time-domain beamformer to time-domain channel estimates per spatial element of the time-domain beamformer; and
determining beamforming weights of the time-domain beamformer based on the time-domain channel estimates per spatial element of the time-domain beamformer.

54. The apparatus of claim 53, wherein the controller circuitry is further configured to cause the apparatus to transform the frequency-domain channel estimates per antenna port of the time-domain beamformer to time-domain channel estimates per spatial element of the time-domain beamformer based on the following operations:
transforming the frequency-domain channel estimates per antenna port of the time-domain beamformer to frequency-domain channel estimates per spatial element of the time-domain beamformer; and
transforming the frequency-domain channel estimates per spatial element of the time-domain beamformer to time-domain channel estimates per spatial element of the time-domain beamformer.

55. The apparatus of claim 53, wherein the controller circuitry is further configured to cause the apparatus to determine the beamforming weights of the time-domain beamformer based on the following operations:
discarding time-domain channel estimates having power below a noise power threshold of the time-domain beamformer, thereby obtaining a pruned channel estimation of the time-domain beamformer; and
determining the beamforming weights of the time-domain beamformer based on the pruned channel estimation of the time-domain beamformer.

56. The apparatus of claim 55, wherein the controller circuitry is further configured to cause the apparatus to determine the noise power threshold of the time-domain beamformer based on one or more of the following: an estimated noise variance, a presumed noise distribution, and an expected maximum noise power per tap.

57. The apparatus of claim 50, wherein:
the beamforming is implemented using a cascade of beamformers comprising the following: at least one instantiation of the time-domain beamformer, and at least one frequency-domain beamformer; and
the controller circuitry is further configured to cause the apparatus to:
apply the determined beamforming weights of the time-domain beamformer to received fullband reference signaling to produce beamformed fullband reference signaling, wherein the fullband reference signaling comprises reference signaling with the communication bandwidth; and
provide the beamformed fullband reference signaling at antenna ports of the frequency-domain beamformer.

58. The apparatus of claim 57, wherein the controller circuitry is further configured to cause the apparatus to:
determine a fallback beam for the frequency-domain beamformer, wherein the fallback beam comprises a spatial element with a strongest time-domain channel estimate among spatial elements of the time-domain beamformer; and
provide an indication of the fallback beam to the frequency-domain beamformer.

59. The apparatus of claim 57, wherein the controller circuitry is further configured to cause the apparatus to perform one or more of the following:
provide an indication of discarded time-domain channel estimates to the frequency-domain beamformer; and
determine the noise power threshold of the time-domain beamformer based on a channel estimation quality difference between the time-domain beamformer and the frequency-domain beamformer.
